(19) United States
(12) Patent Application Publication
(10) Pub. No.: US 2002/0038227 A1
(43) Pub. Date: Mar. 28, 2002

(54) Method for centralized health data management

(76) Inventors: Christopher T. Fey, Jacksonville, FL (US); Fred W. Fey, Ponte Vedra Beach, FL (US); Kathy M. Fleming, Ponte Vedra Beach, FL (US); John W. Franks, Jacksonville, FL (US); Paul S. Kasinski, Jacksonville, FL (US); Eduardo J. Balbona, Jacksonville, FL (US); Leah M. Nelms, Jacksonville Beach, FL (US); Staci J. Presley, Jacksonville, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 09/793,238

(22) Filed: Feb. 26, 2001

Related U.S. Application Data
(60) Provisional application No. 60/184,961, filed on Feb. 25, 2000.

(51) Int. Cl. G06F 17/60

(52) U.S. Cl. 705/3

(57) ABSTRACT

A centralized health screening and data mangement system is provided. Specifically, the invention includes a method, system, and computer program for maintaining a centralized health screening and data mangement system in communication with a plurality of screening facilities, such screening facilities including mobile units for dispatch. The screening facilities (and mobile units) provide for collecting health data and conducting tests. The data and test results are transmitted to the centralized health screening and data mangement system for analysis and storage in a manner that is accessible for report generation and aggregate information analysis.

### CROSS-REFERENCE TO RELATED APPLICATIONS

This application claims priority from U.S. provisional application, serial No. 60/184,961, filed Feb. 25, 2000, and U.S. patent application Ser. No. not yet assigned, filed Feb. 23, 2001 under Attorney Docket Number HSA-101XC1 entitled “Method, System and Computer Program for Health Data Collection, Analysis, Report Generation, and Access,” the disclosures of which are incorporated herein by reference in their entirety.

### COPYRIGHT NOTICE

A portion of the disclosure of this patent document, including certain figures, contains material which is subject to copyright protection. The copyright owner has no objection to the facsimile reproduction by anyone of the patent document or the patent disclosure as it appears in the patent file or records, but otherwise reserves all copyright rights whatsoever.

1 Technical Field

The present invention relates to centralized health screening and management. Specifically, the invention relates to a method, system, and computer program for maintaining a centralized health screening and data mangement system in communication with a plurality of screening facilities, such screening facilities also having mobile units for dispatch. The screening facilities (and mobile units) provide for collecting health data and conducting tests. The data and test results are transmitted to the centralized health screening and data mangement system for analysis and storage in a manner that is accessible for report generation and aggregate information analysis.

2. Background Art

The diseases that kill most Americans are silent thieves, leaving few clues that they are robbing individuals of good health. By the time symptoms appear, the disease is often in an advanced, sometimes fatal, stage.

Heart disease is the number one killer of adults in America. While most heart patients have no warning prior to their first heart attack, the health community now recognizes that the buildup of plaque in coronary arteries is responsible for all heart attacks. Yet, plaque does not occur overnight. It builds up over time—often as long as 10 to 20 years—before becoming severe enough to block the coronary arteries, leading to a heart attack. Traditional stress tests detect plaque in very advanced stages, when there is more than 70% blockage. Yet, 68% of heart attacks occur when blockage is less than 50%. Early detection can lead to lifestyle changes and preventive treatment, saving lives and millions of dollars in intensive care treatment.

Cancer is the number two killer of adults in our country. Early detection often makes the difference between survival and fatality. Pre-cellular changes leading to cancer often occur in the body up to 10 years prior to the formation of a tumor. While early detection strategies are common for cancers of the breast, colon and prostrate, no early detection strategy for lung cancer is widely utilized. Yet, lung cancer will kill more Americans than all of the above-mentioned cancers combined. Recent studies show the use of low-dose CT Scan can detect four times the number of lung cancers as compared to traditional chest x-rays. Moreover, these cancers are six times as likely to be discovered at the earliest stage (Stage 1) when the chances for a cure are best. Yet most insurance carriers do not cover the cost of early detection screening for lung cancer. While insurance companies may authorize chest x-rays, standard x-rays do not differentiate between irregular nodules less than two centimeters in the lungs. Detection when the nodule is less than two centimeters increases lung cancer survival rates from 20% to 80%. Again, early detection and accurate risk assessment can lead to preventive treatment and positive lifestyle changes for those not yet dealing with full-blown cancer. For those with malignant tumors, early detection while tumors are small and localized greatly increases survival rates and quality of life for those survivors. “Despite a booming economy, lack of access to health care continues to be a problem in the United States. The number of individuals without health insurance has increased from 31 million in 1987 to more than 43 million in 1997, and over 70 million lacked insurance for at least one month between 1993 and 1996” (Qtd from Family & Community Health, Betsy Smith-Campbell, Apr. 1998). For millions of uninsured Americans, regular visits to physicians and routine screening tests are considered an expensive luxury, one that is often put off until debilitating symptoms appear. According to the Florida Health Association, research by the Kaiser Family/Commonwealth Fund Study revealed two out of every five uninsured Americans did not seek needed medical care in 1997. Too often, uninsured citizens do not receive any medical attention until they arrive at the hospital emergency room. By that time, care is reactive, not preventive and the cost is far greater and treatment comes too late to ensure optimum life quality and longevity. For instance, a 52 year-old male presents at the emergency room with pain in his chest and running down his arm, shortness of breath and dizziness. He is experiencing a heart attack, and the treatment provided to him over the ensuing 24 hours could easily run over $20,000. Had he been screened earlier with a CAT scan for his heart, ankle brachial test and cholesterol levels, he may have avoided the heart attack with some simple, life-style changes and relatively inexpensive medication, perhaps an aspirin a day.

Even those with insurance are not guaranteed access to medical screening tests that can save lives. Insurance companies, faced with exploding costs, feel a fiscal responsibility to wait for irrefutable proof that a particular screening test saves a substantial number of lives before authorizing its use. “There are 90 million smokers in this country. If they all want a CAT lung scan every year, it would cost $400 each—and that's a big number,” said Allan Kom, chief medical officer for Blue Cross/Blue Shield Association. “We're still studying whether it would make a difference in overall survival” (qtd. in USA Today, May 25, 2000). Typically, studies determining that level of proof take 10 to 15 years and are dependent upon finding to complete. In fact, NCI is beginning a 15-year study of 100,000 clinical trial subjects. Millions of individuals will die of lung cancer awaiting the results. Consumers, many of whom are aging baby-boomers, demand more control over their health care and more immediate access to potentially life-saving health screening.

In addition, our society is a mobile one. Families move an average of 8 times and no longer see the same general practitioner throughout their lives. Many adults travel on business and pleasure. There is a need for quick access to medical records should an emergency arise while away from home. Millions of Americans are covered under HMOs. If their primary care or specialty physicians leave the health care network, these consumers must transfer their records to newly-assigned physicians. Often transferring records involves a fee and an extended wait time, up to several weeks.

In addition, many physicians are compelled to get authorizations for most tests and may face stringent limitations when ordering tests. A-symptomatic patients are rarely given authorizations for many potentially life-saving screening tests.

All of these factors point to a pressing need for a system and method that encourages wellness care through affordable health screening tests available directly to consumers, secure storage of those tests' results, and lifelong storage of health records. Further, there is a need for immediate access of those records by the client and attending physician. There is a need for custom reports generated at the time tests are performed and additional reports generated as needed. There is a need for an educational component to the reports that explains the results, the risk assessment, resources available to learn more and, possibly, lifestyle recommendations based on the results. An added benefit of this needed system, method and computer program is the compilation of tremendous data accumulated on a largely pre-symptomatic population. Such data can be used not only to analyze medical trends but can provide proof of the effectiveness of health screenings when accompanied by full explanations of the results and educational resources to learn more about potential conditions, prevention, wellness programs and treatment options. There is a need for a business process that maximizes the productivity of every component through efficient operations streamlined procedures to insure cost effectiveness while providing highly accurate, state of the art screening results.

While a number of patents have been issued dealing with more efficient gathering and dissemination of patient information, all have been solely for use by the medical community. Thus, the consumer does not experience greater control over individual health or a reduction in the cost of necessary, possibly life-saving screening tests. In addition, the medical databases used in the current processes are primarily built with data from symptomatic patients, rather than a population more reflective of the general population.

U.S. Pat. No. 6,014,630 to Jeacock & Nowak is comprised of a database system of various medical procedures, practices of individual physicians, methods followed by various medical facilities and a program to select desired ones for a particular patient with the capability of modification by the doctor. The program produces a personalized patient document that explains the procedure and follow-up care. While the document produced is educational for the patient, it is limited to one particular treatment by a specific doctor. The stated purpose is to protect the physician and facility from a malpractice suit due to lack of patent knowledge or understanding. It is not intended to increase a patient's control over health or to educate the patient on preventive care techniques to enhance wellness.

U.S. Pat. No. 6,151,581 to Kraftson, et al is for a system and method of collecting and populating a database with physician/patient data for processing to improve practice and quality healthcare. This invention seeks to build and administer a patient management and health care management database through the use of surveys to analyze the quality of care. While this invention seeks to improve patient care through the collection of data, the data relied upon is based solely upon a variety of surveys, thus is subjective rather than objective. It is also intended for the exclusive use of the medical community, not the individual consumer.

U.S. Pat. No. 5,796,759 to Eisenberg, et al is for a system and method for assessing the medical risk of a given outcome for a patient. The method comprises obtaining test data from a given patient corresponding to at least one test marker for predicting the medical risk of a patient and transforming the data with the variable to produce transformed data for each of the test markers. The transformed data is compared with the mean and standard deviation values to assess the likelihood of the given outcome for the given patient and the database is updated with the actual occurrence for the given patient, whereby the determined mean and standard deviation will be adjusted. The patent does provide a basis for risk assessment that is constantly updated as data changes. However, it is limited to already symptomatic patients undergoing treatment—in this case, maternity patients. It provides a useful tool for the medical community regarding high-risk pregnancies but cannot be used to predict overall health trends among the general population. It also does not incorporate a program to educate the consumer or inform the consumer of possible preventive care or lifestyle changes to minimize risk.

U.S. Pat. No. 6,101,479 to Shaw is a system and method for allocating the resources of an organization. The method includes the steps of acquiring the information required to construct a model of the organization's primary processes as viewed from the perspective of a customer. The organization's resources are then allocated to the process whose improvement will have the greatest effect on customer-based performance measures of the organization. It provides a useful tool for implementing total quality control in a manner that has the greatest impact on a customer's perception of the organization. It does not implement quality control changes that enhance the overall effectiveness of the organization, including those areas beyond the customer's purview. It does not incorporate new strategies that ultimately benefit the consumer by maximizing efficiency to maintain reasonable costs while constantly striving for additional benefits and greater accuracy.

Medical screening can locate problems early so individuals can take appropriate action. However, the results of most lab reports are incomprehensible by most consumers and are often sent directly to doctors without even informing consumers of the results. Moreover, data from such screenings is often not collected, saved, analyzed or utilized by consumers, doctors, or research organizations which could benefit from such a-symptomatic heath screening data and demographics associated therewith.

Therefore, there is a need in the art for a method by which consumers can take charge of their health. There is also a need in the art for consumers to be able to receive and comprehend data from their screenings and maintain such data as a life-long health record. There is a need for such a record to be readily accessed and updated. There is also a need for the ability to collect, analyze and maintain aggregate a-symptomatic heath and demographic data for scientific research which may ultimately lead to the prevention and cure for disease.

### BRIEF SUMMARY OF THE INVENTION

The present invention solves the above-stated problems in the art by providing method, system, and computer program for maintaining a centralized health screening and data mangement system in communication with a plurality of screening facilities, such screening facilities including mobile units for dispatch. The screening facilities (and mobile units) provide for collecting health data (e.g., demographic, diagnostic, screening). The data and screening test results are transmitted to the centralized health screening and data mangement system for analysis and storage in a manner that is accessible for report generation and aggregate information analysis.

Features of the invention can be implemented in numerous ways, including as a system, a method, a computer site, or a computer readable medium. The invention preferably relies on a communications infrastructure, for example the Internet, wherein individual interaction is possible. Several embodiments of the invention are discussed below.

As a computer system, part of the invention generally includes a database and a processor unit. The processor unit operates to receive information (health, diagnostic, and demographic) about an individual and to analyze the received information in conjunction with the statistical/known information (e.g., disease symptoms, risk factors, blood studies, screening factors) to generate customized detailed reports both for the individual and his physician. The reports may include print or electronic media.

The printed report preferably includes results from the screening with analysis and recommendations, educational information, as well as a summary for the physician.

Part or all of the data can also be sent electronically or telephonically, with devices such as fax back, and maintained on a web server for confidential access with typical browsers. The data may be accessed or sent to medical practitioners or others at the discretion and direction of the consumer. The health and demographic data collected from the screening can pre-populate a life-long health record to avoid the need for the consumer to complete long medical information forms. The data may also be transmitted and viewed by other well known techniques such as email, interactive television, and the like. The computer site is preferably viewed with a client web browser as an HTML document through a web secure server communicating with an application server having a database associated therewith.

Screening test results may be used in conjunction with carefully formatted health risk assessment questionnaires which identify increased risks associated with social habits and behaviors as well as personal health history and familial history to better assess the individual consumer's risk and identify whether that individual may qualify to participate in and benefit from a specific clinical study. In addition, the aggregate data can be used to forecast trends and evaluate medical probabilities based on a population that more closely matches the general population. Questions in the health risk assessment should be based upon findings from prior scientific studies such as the Framingham study and/or reliable sources recognized by the medical community such as the American Heart Association and the American Cancer Association.

As a computer readable medium containing program instructions for collecting, analyzing and generating output, an embodiment of the invention includes computer readable code devices for interacting with a consumer as noted above, processing that data in conjunction with analytical information, and generating unique printed or electronic media for that consumer.

As data is collected from individual consumers, the aggregate of information may also be maintained and utilized for scientific research and studies.

The advantages of the invention are numerous. First and foremost, the invention provides for a method by which consumers can take charge of their health, allowing them to receive and comprehend data from their screenings and main such data as a lifelong health record. Linking the screening phase to the on-line health record provides the consumer with an easier means to begin and maintain such a health record by pre-populating a majority of the data fields from data already collected during the screening process. A resulting advantage is the ability to collect, analyze and maintain aggregate a-symptomatic heath, diagnostic, and demographic data for scientific research.

Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification. The following patents are incorporated herein by reference: U.S. Pat. No. 6,192,416 to Baxter, U.S. Pat. No. 6,154,726 to Rensimer, U.S. Pat. No. 6,151,581 to Kraftson, U.S. Pat. No. 6,148,297 to Swor, U.S. Pat. No. 6,144,837 to Quy, U.S. Pat. No. 6,122,351 to Schlueter, U.S. Pat. No. 6,022,315 to Iliff, U.S. Pat. No. 6,018,713 to Coli, U.S. Pat. No. 6,017,307 to Raines, U.S. Pat. No. 6,016,497 to Suver, U.S. Pat. No. 6,014,630 to Jeacock, U.S. Pat. No. 6,014,626 to Cohen, U.S. Pat. No. 6,002,915 to Shimizu, U.S. Pat. No. 5,995,937 to DeBusk, U.S. Pat. No. 5,991,731 to Colon, U.S. Pat. No. 5,991,730 to Lubin, U.S. Pat. No. 5,987,434 to Libman, U.S. Pat. No. 5,941,820 to Zimmerman, U.S. Pat. No. 5,924,074 to Evans, U.S. Pat. No. 5,890,129 to Spurgeon, U.S. Pat. No. 5,796,759 to Eisenberg, and U.S. Pat. No. 4,315,309 to Coli.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is an overall system block diagram of a preferred embodiment of the present invention.

FIG. 1B is a conceptual model of the centralized health screening and data mangement system of a preferred embodiment of the present invention.

FIG. 1C is a conceptual model of the business model which shows the organizational and consumer relationships.

FIG. 2 is a system flow diagram of a preferred embodiment of the present invention.

FIG. 3 is a hardware diagram of a preferred embodiment of the present invention.

FIG. 4 is an entity relationship model for a preferred embodiment of the present invention.

FIGS. 5A-5B are flow charts of the operation of a preferred embodiment of the present invention.

FIGS. 6A-6N are process and flow diagrams of a preferred embodiment of the present invention.

FIGS. 7A-7W represent a sample client report generated by a preferred embodiment of the present invention.

FIGS. 8A-8H represent a sample group summary report generated by a preferred embodiment of the present invention.

FIG. 9 represents one sample aggregate information report generated by a preferred embodiment of the invention.

FIGS. 10A-10J represent an additional sampling of test results generated by a preferred embodiment of the present invention and available for viewing and downloading from the online lifelong health record.

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DISCLOSURE OF THE INVENTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a method, system, and computer program for maintaining a centralized health screening and data mangement system in communication with a plurality of screening facilities, such screening facilities including mobile units for dispatch. The screening facilities (and mobile units) provide for collecting data and conducting tests. The data and test results are transmitted to the centralized health screening and data mangement system for analysis and storage in a manner that is accessible for report generation and aggregate information analysis.

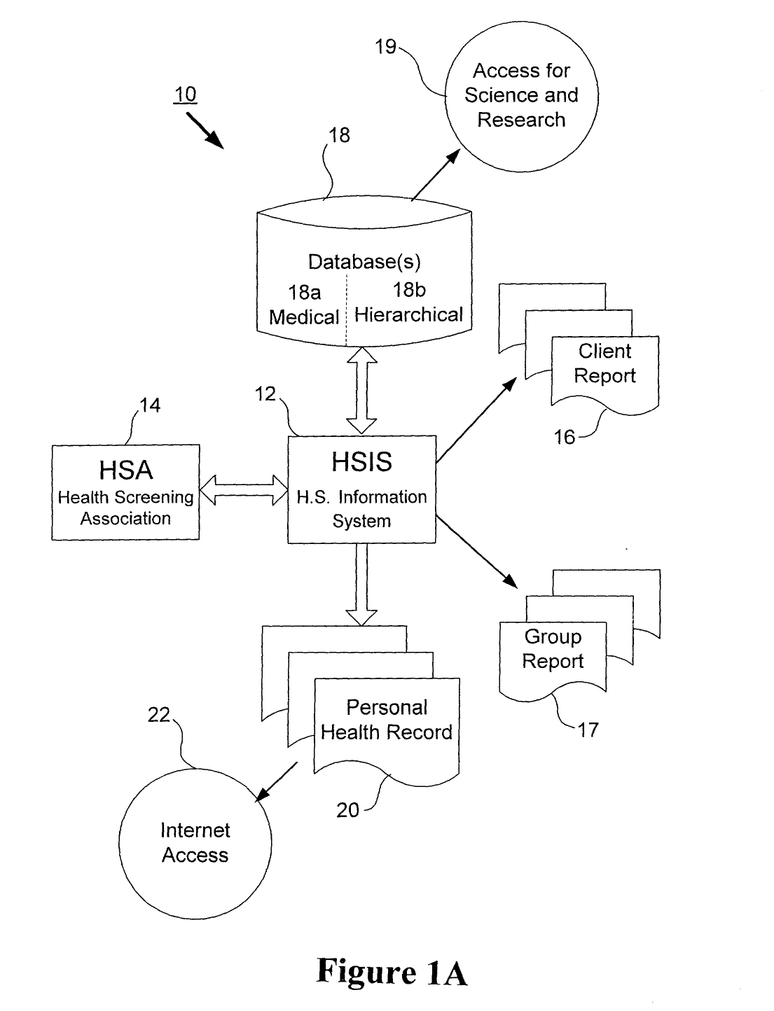

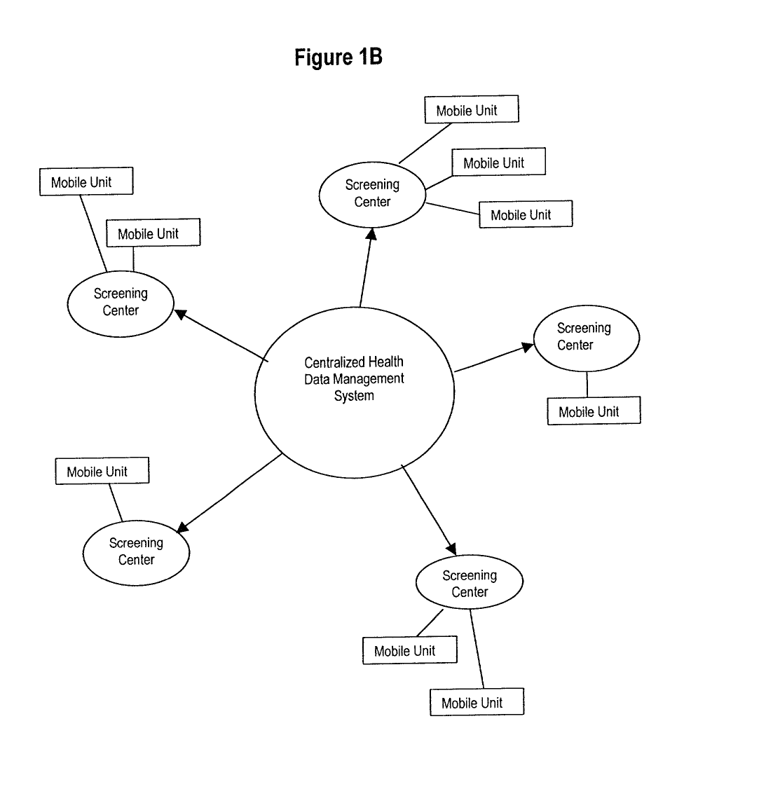

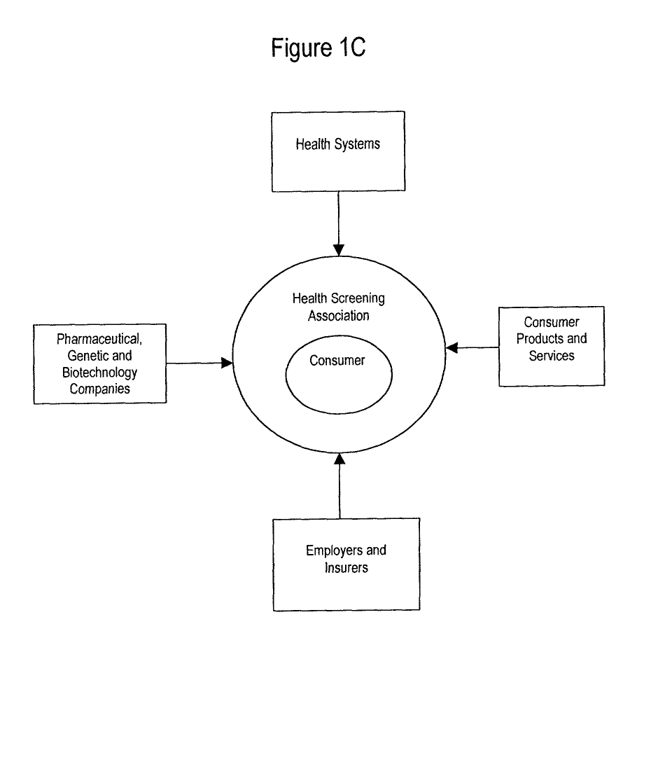

FIG. 1A shows an overall system block diagram of a preferred embodiment of the present invention. Central to the health screening and data mangement system 10 is the Health Screening Information System (HSIS) 12 which is associated with a Health Screening Association (HSA) 14 to carry out the aspects of the present invention. The HSA may consist of various clinics, mobile units, screening facilities, and the like which provide for screening of clients, and collecting screening and demographic data therefrom. The HSA 14 communicates with the HSIS 12 for processing and analyzing the data. Custom reports are generated, both at the client level in the form of a client report 16 and at a collective level in the form of a group report 17. The system data is maintained in a database 18. This data may be accessed in aggregate form by various institutions and researchers 19 for scientific research. The system also provides for user access to electronic personal health records 20 via the Internet 22 or other electronic communication means (such as fax back system).

FIG. 1B shows the relationships between the centralized health screening and data mangement system with its associated remote screening centers (SC) and their respective mobile units. The preferred embodiment provides for a plurality of remotely located screening facilities and a centralized health screening and data mangement system which communicates with each of the screening facilities. The screening facilities provide for (a) gathering information from a client, the information including demographic data, health data, and risk assessment data; (b) conducting a medical screening on the client (at least one test); (c) transmitting the information and results to the centralized health screening and data mangement system; and (d) generating a report for the client according to an analysis of the results taken in conjunction with the information provided by the health screening and data mangement system. The screening facilities may also be referred to herein as screening centers (SC). The screening centers usually have associated therewith at least one mobile unit to dispatch to a remote location. The mobile units are configured specifically for each location for which said mobile unit is dispatched. The screening center provides for replication of data in the mobile unit. The data received by the mobile unit is transmitted for storage in the centralized health data management system.

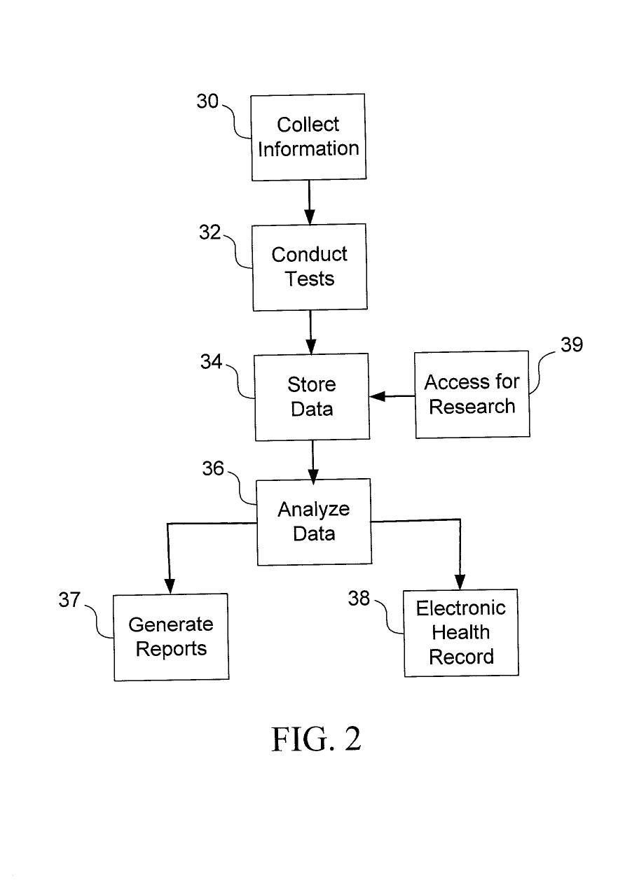

A brief overview of the system will now be described with reference to the process shown in FIG. 2. Initially, demographic information is collected about the consumer in step 30. Health screening tests are also conducted to collect health data in step 32. Typical screening tests include, but are not limited to, ankle brachial index, abdominal aortic aneurysm, carotid ultrasound scan, thyroid ultrasound scan, osteoporosis screening, body composition, blood and pulse pressure, oxygen saturation, hearing screening, vision screening, urine analysis, blood studies (PSA, blood count, chemistry panel, lipid panel, triglycerides and risk ratio, thyroid blood test, C-reactive protein, fibrogen, homocysteine, CEA, CA-125), hormones, CT scans. This data, as well as other relevant data, is input into the system in step 34 manually or directly from the screening devices. The health, diagnostic, and demographic data is analyzed in step 36 in conjunction with known medical/statistical data (e.g., disease symptoms, risk factors, blood studies, screening factors). The system may utilize various algorithms, real-time learning and inference technology, profiling, pattern recognition learning algorithms, neural networks, and the like in order to correlate medical/statistical information with the collected data. The necessary medical/statistical information can be gathered from various known sources or acquired and continuously updated as the database acquires information from each new consumer.

After the analysis, the next step in the process is to generate in real-time a report for the individual consumer in step 37 (or for a group of consumers, e.g., a workplace). The personalized health record reviews individualized health risks and thoroughly explains test results with followup recommendations. Furthermore, a personalized health assessment is provided to determine further health risks.

The present invention also utilizes the consumer's information to pre-populate a “life-long health record” accessible on the Internet (or other communication means such as, but not limited to, a fax back system) in step 38. This record stores the test results, plus medical history including allergies, medications, immunizations, insurance and physician information. From this site, comsumers can store, retrieve and analyze personal medical data about themselves and their family in a secure environment. The site allows consumers to track their own health progress and tap into a huge library of medical information. Each time a consumer is screened, the results will be added to the site. The results may also be made available to consumers by other electronic communication means such as facsimile devices, e-mail, and the like.

The aggregate of collected information is also maintained on the centralized system. This information can be accessed in step 49 and utilized by doctors and researchers to discover trends, conduct scientific research, and study a-symptomatic health data.

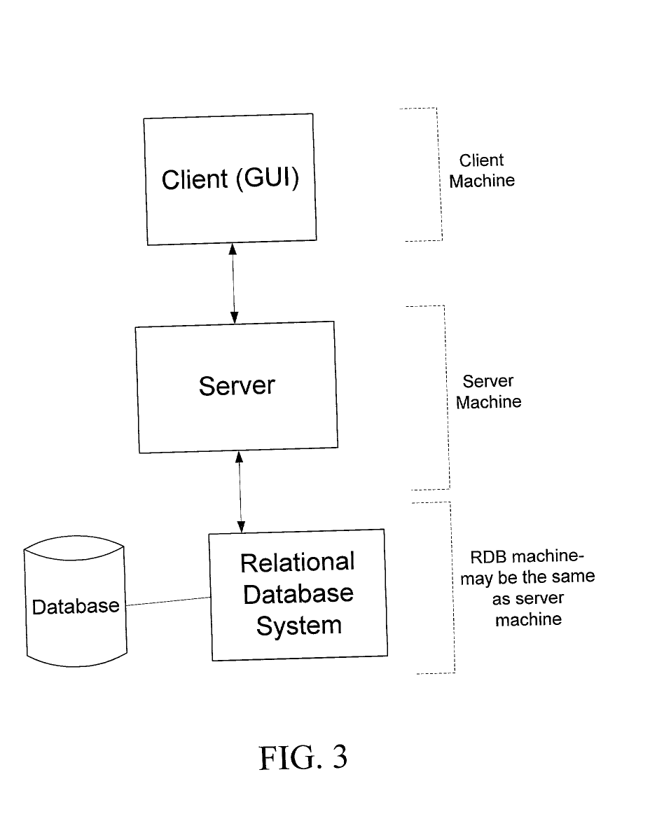

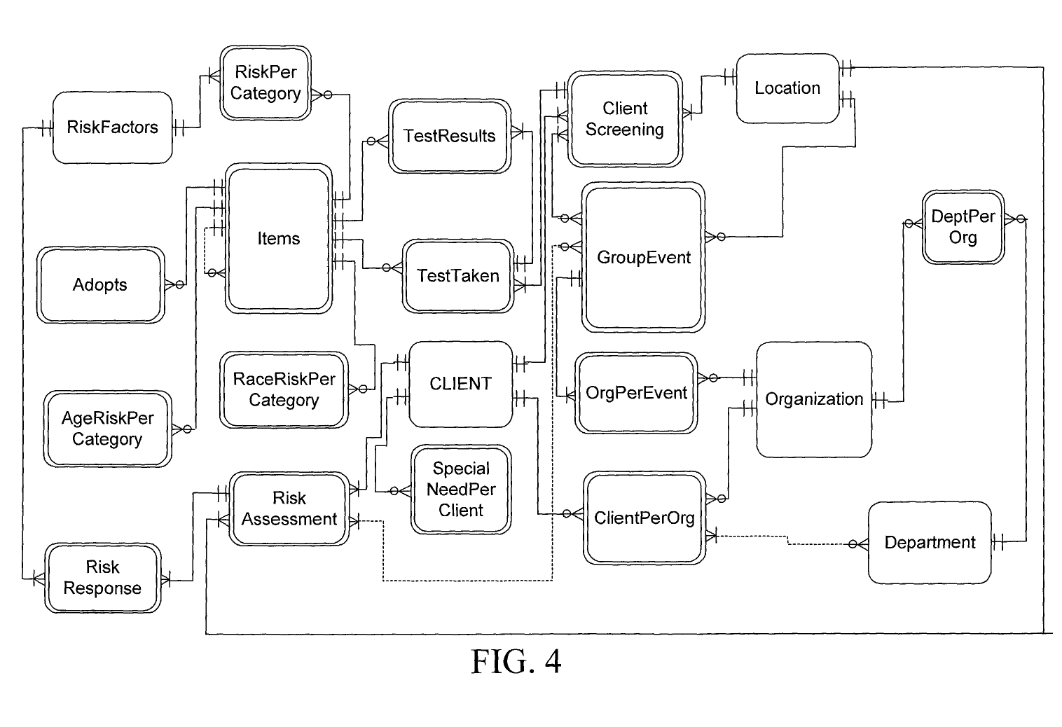

FIG. 3 shows the preferred architecture of the present invention. The system comprises at least two networked computer processors (client component(s) for input and server component(s)) and a database(s) for storing data. The computer processors can be processors that are typically found in personal desktop computers (e.g., IBM, Dell, Macintosh), portable computers, mainframes, minicomputers, or other computing devices. Preferably in the networked client/server architecture of the present invention, a classic two or three tier client server model is utilized. Preferably, a relational database management system (RDMS), either as part of the Application Server component or as a separate component (RDB machine) provides the interface to the database.

In a preferred database-centric client/server architecture, the client application generally requests services from the application server which makes requests to the database (or the database server). The server(s) (e.g., either as part of the application server machine or a separate RDB/relational database machine) responds to the client's requests.

More specifically, the input client components are preferably complete, stand-alone personal computers offering a full range of power and features to run applications. The client component preferably operates under any operating system and includes communication means, input means, storage means, and display means. The user enters input commands into the computer processor through input means which could comprise a keyboard, mouse, or both. Alternatively, the input means could comprise any device used to transfer information or commands. The display comprises a computer monitor, television, LCD, LED, or any other means to convey information to the user. In a preferred embodiment, the user interface is a graphical user interface (GUI) written for web browser applications.

The server component(s) can be a personal computer, a minicomputer, or a mainframe and offers data management, information sharing between clients, network administration and security. The Database Server (RDBMS - Relational Database Management System) and the Application Server may be the same machine or different hosts if desired.

The present invention also envisions other computing arrangements for the client and server(s), including processing on a single machine such as a mainframe, a collection of machines, or other suitable means. The client and server machines work together to accomplish the processing of the present invention.

The database(s) is preferably connected to the database server component and can be any device which will hold data. For example, the database can consist of any type of magnetic or optical storing device for a computer (e.g., CDROM, internal hard drive, tape drive). The database can be located remote to the server component (with access via modem or leased line) or locally to the server component.

The database is preferably a relational database that is organized and accessed according to relationships between data items. The relational database would preferably consist of a plurality of tables (entities). The rows of a table represent records (collections of information about separate items) and the columns represent fields (particular attributes of a record). In its simplest conception, the relational database is a collection of data entries that “relate” to each other through at least one common field.

Description of Preferred Embodiment

The following detailed description of the preferred embodiment presents a description of certain specific embodiments to assist in understanding the claims. However, one may practice the present invention in a multitude of different embodiments as defined and covered by the claims.

For convenience, the description comprises three sections: the overview and architecture of the concentric business method and apparatus; the process used with the individual consumer and the organization; and the storage of the demographic and screening information for analysis and report generation.

I. Overview and Architecture of the Concentric Business Method and Apparatus

Health screening, offered directly to consumers without the need of a physician's referral or an insurance company's authorization, is at the center of the concentric business method, illustrated in FIG. 1C. Appropriate screening tests for this business method are those not usually offered during an annual checkup unless symptoms are clearly present. The purpose is to offer tests to a largely a-symptomatic population in order to find and correct problems while the conditions are reversible before they may become chronic or fatal. In the preferred embodiment, screening tests are conducted with FDA approved, cutting-edge technology by experienced health professionals supervised by board-certified physicians. Tests may be designed to increase the comfort level of the client by ensuring as little discomfort as possible through painless non-invasive procedures that do not require disrobing to complete. Clients' comfort levels may further be raised through personal and immediate attention without the typical long waiting periods many people experience when completing physician ordered tests in other environments. In the preferred embodiment, patients are treated like preferred consumers whose time is valuable and right to know is paramount. Whenever tests do not require review by a certified physician, test results may be available immediately.

The health screening facility surrounds the consumer in the center of the concentric business method, acting as both a buffer zone and a facilitator between the consumer and the community at large, including the medical research community, the consumer's employer or potential employer and health care providers. The facility protects the consumer's privacy through careful storage in a database of screening test results and data, allowing access to the consumer's records only under the direction of the consumer and only in an anonymous manner that totally protects the consumer from any chance of personal information becoming public. At the same time, the facility matches helpful information, educational and clinical opportunities to the consumer, as long as the consumer permits the facility to do so, acting as a bridge between the medical community and the consumer. For instance, if the anonymous screening and assessment test results reveal a close fit for a clinical study, the facility provides information on the study to the consumer. If the consumer expresses interest in pursuing the opportunity, the facility would release the consumer's contact information to the researchers. Thus, the consumer experience has the optimum opportunity to benefit from cutting-edge medical advancements without endangering personal privacy.

The health screening facility is responsible for the process of storing test and health risk assessment results, FIG. 1C. At the center of the architecture for this layer is a computer with sufficient space to create and maintain space required for storage of the demographic, diagnostic and screening data, multiple informational tables and educational information. Test results and pertinent information from the tables may be included in a client test result report as well as a variety of other reports issued upon request. A medical database is created on the host computer. The medical database is comprised of two databases: the primary, relational database and a subsidiary, hierarchical database that contains all the tables of information, including but not limited to normal ranges of test results and risk assessments. Accurate tables populated with the most current information available from the most reliable medical resources are essential. The subsidiary database is more static and information is automatically pulled from there to populate specific fields in the reports generated in the primary database which operates in real-time.

In the preferred embodiment, the database script is written in SQL and the source code in Visual Basic, but they may be written in any combination of computer languages capable of creating both hierarchical and relational, object-oriented databases with communication embedded between them. Report software may also be utilized. In the preferred embodiment, Seagate Crystal Reports and Microsoft Excel are utilized, but any database management tool or system that is SQL compatible may be used including, but not limited to, Oracle and DB2. When information is pulled from SQL, it is put into Crystal Report for report generation and information analysis.

Additional workstations equipped with computers and printers may be used at point of service to enter demographic and screening data as well as generate appropriate reports, if desired. In the preferred embodiment, each computer at a permanent location has a shortcut on the desktop to the application that has a connection to the relational database. Computers in remote mobile units are preferably not connected to the primary database. Instead they are connected to a mobile server and use a merge replication to ensure autonomous function without a direct connection to the primary database. A production server is used for the permanent workstations.

In the preferred embodiment, mobile units may be transported any place in the world because each unit contains a mobile server and medical testing equipment, shipped in carefully-fitted rugged containers for safety and portability. To ensure efficiency, the mobile units would be transported from the permanent screening site closest to the health event. The preferred embodiment of this business model could include multiple health screening sites and one centrally located corporate headquarters, as illustrated in FIG. 1B. The corporate headquarters would be the hub, providing the centralized health screening and data mangement system which supports the screening facilities, which are the spokes in this analogy. The centralization of services in the health data management system, such as information technology, marketing, storage, analysis, and the like, provides maximum efficiency and cost containment, keeping the cost of health screening as reasonable as possible and therefore, affordable to a greater number of consumers.

Mobile units, located at the spokes (screening facilities) may be re-configured as the health event dictates so that only the medical testing equipment, server and portable workstations needed for that event are moved. Transportation may be by ground, air or sea as the metal containers meet all shipping requirements. Replication of data in mobile units ensures the data can be accurately entered wherever the health event may be located. When merged, the data becomes part of the information in the relational database and it signals the subsidiary database, just as data entered from permanent locations does.

The mobile units may communicate with the HSIS in a number of ways. For example, there may be provided a method of propagating data throughout a computer system having mobile computers, and a computer server device at a fixed site (e.g., closest screening center), the method comprising providing relevant data at the computer server device to be transferred to the mobile computers, making a data exchange connection between a mobile computer and the computer server device when a mobile computer visits the site, providing software authorization checking when the data exchange connection is made to determine if the mobile computer is an authorized computer, conducting software checking to determine if relevant data resident in the computer server device is more recent than the relevant data in the mobile computer, invoking further software to transfer the relevant data from the computer server device to the computer if it is more recent than the relevant data in the mobile computer, and if the relevant data in the mobile computer is more recent than the relevant data in the computer server device, invoking further software to transfer the relevant data from the mobile computer to the computer server device, and repeating the process with further mobile computers when they visit the site whereby the relevant data can be propagated.

The subsidiary, hierarchical database is essentially a lookup database. In the preferred embodiment, List Manager is used. Hierarchical logic is incorporated in the program. The tables are composed of tasks, categories, tests, expected results, and the format of the expected results. Each test attribute has a unique identification number (ID#) which corresponds to the event in the List Manager.

Since the medical database contains consumers' health and information, strong security in the form of a firewall is used. In the preferred embodiment, further security protection is incorporated. For example, each client may be assigned an unique 14-digit identification number, rather than a more traceable identifier such as a Social Security number.

An Internet or business network (ITP connection) is used to support the database internally and an Internet web site accessible by all with several degrees of secured access is used to allow immediate, remote access to records and relevant educational information for both clients and physicians.

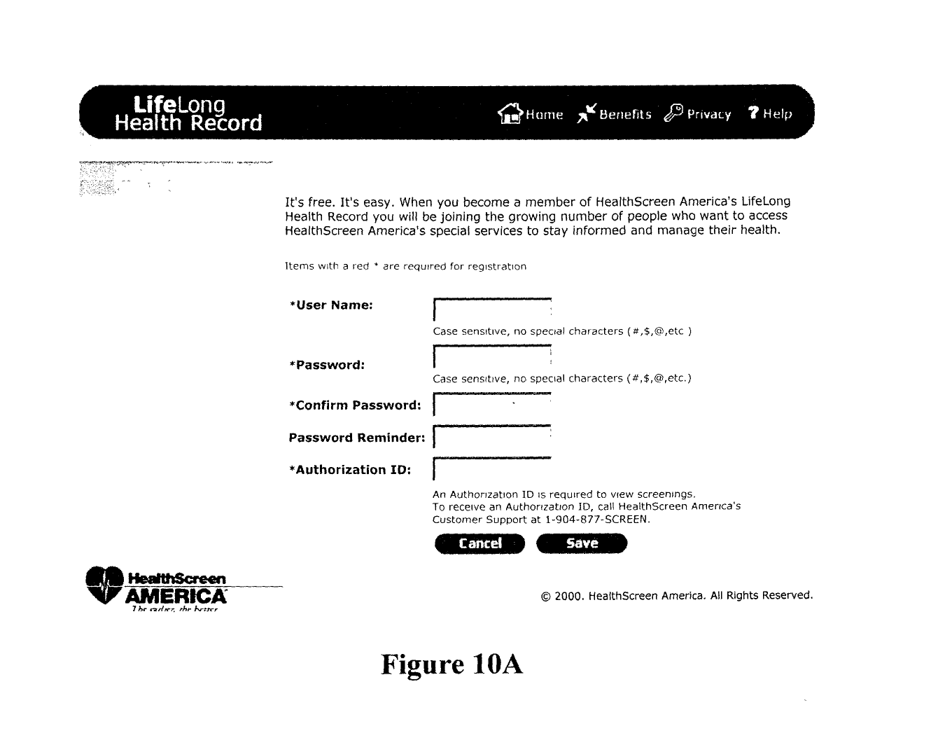

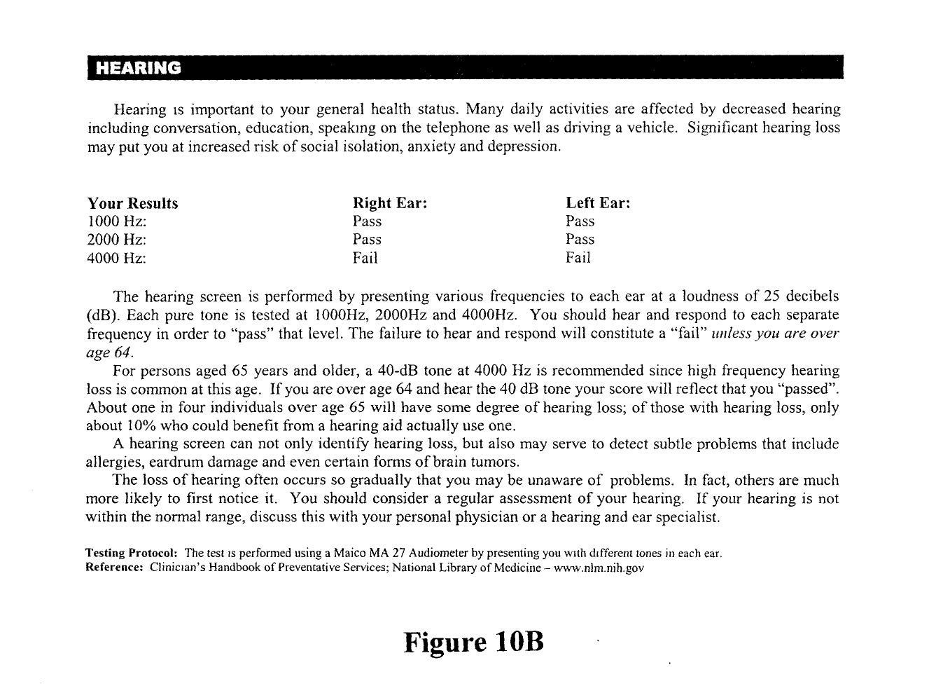

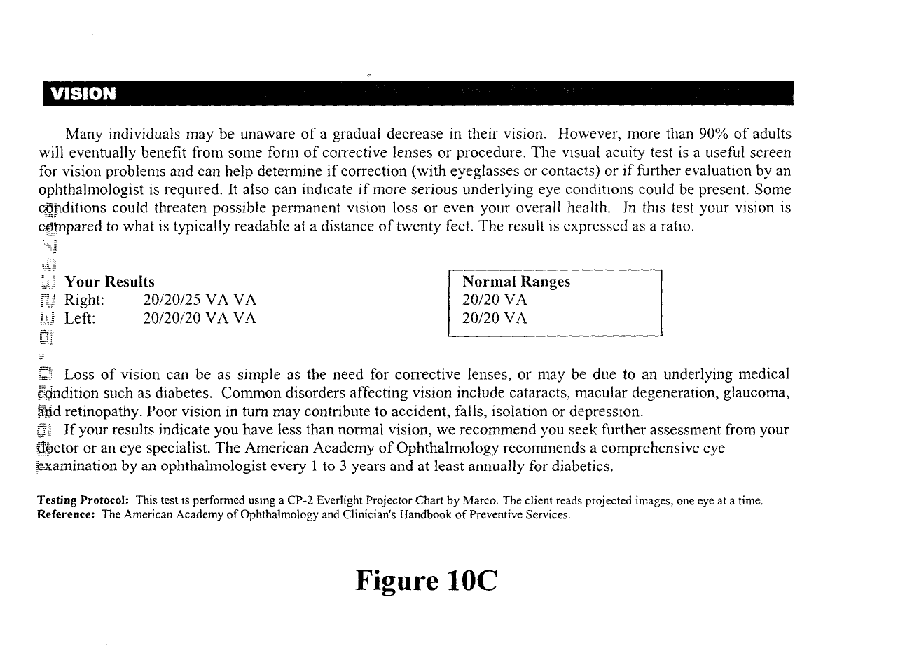

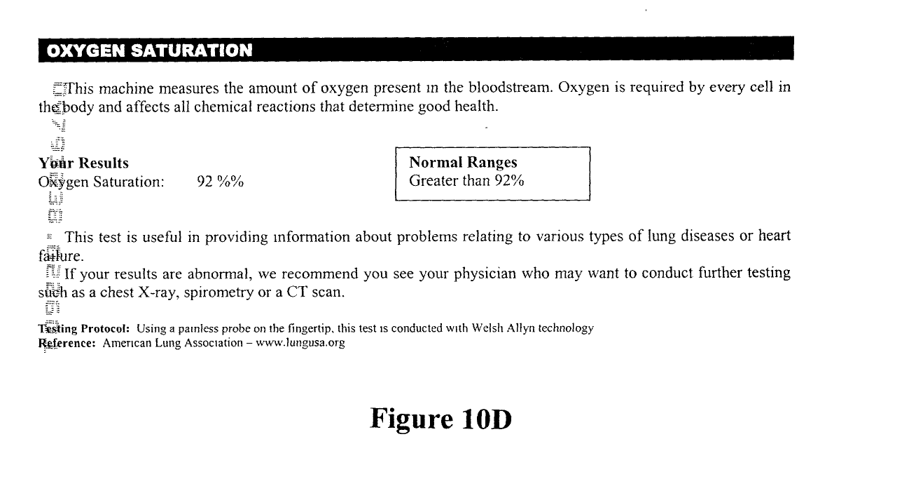

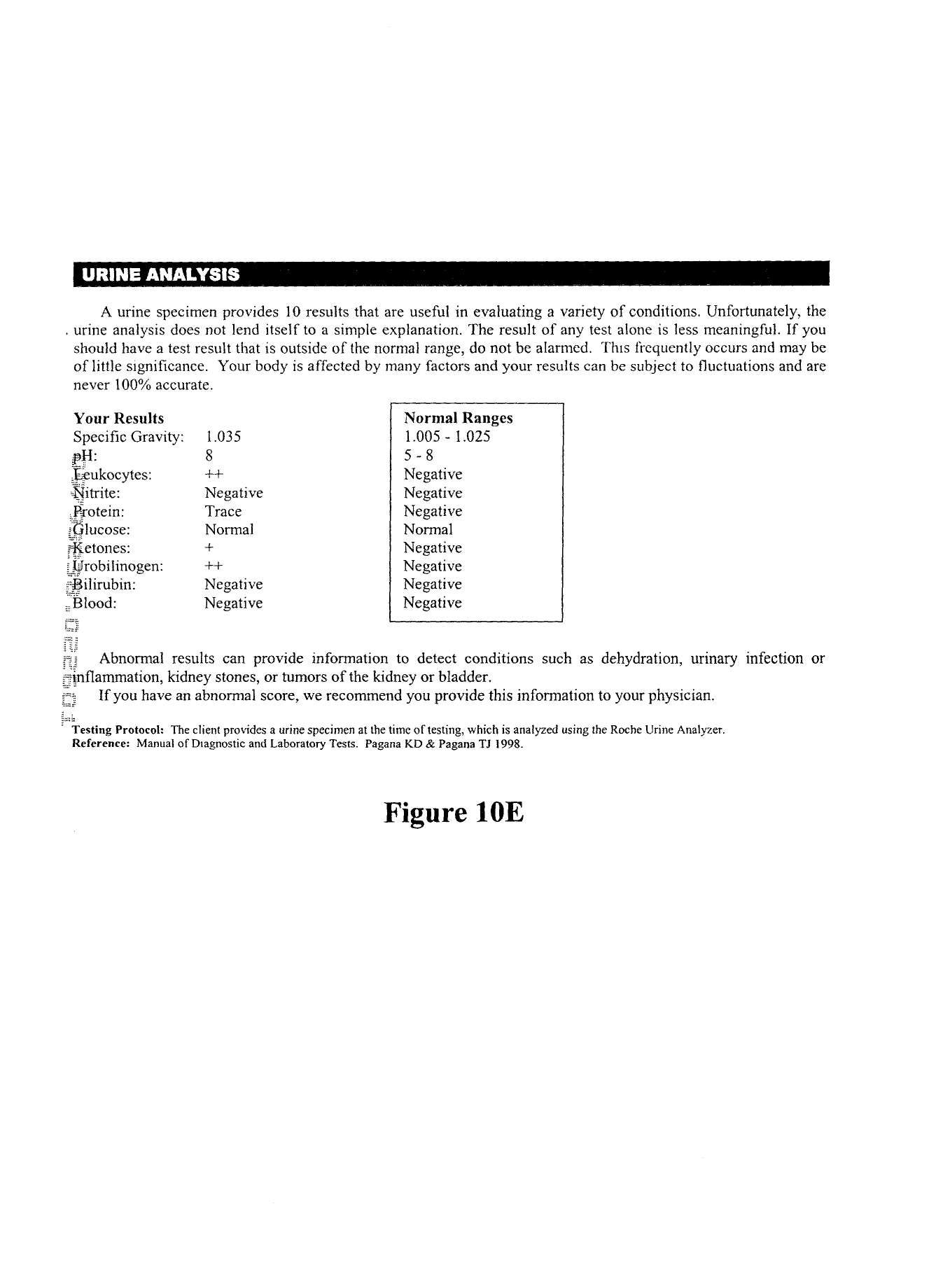

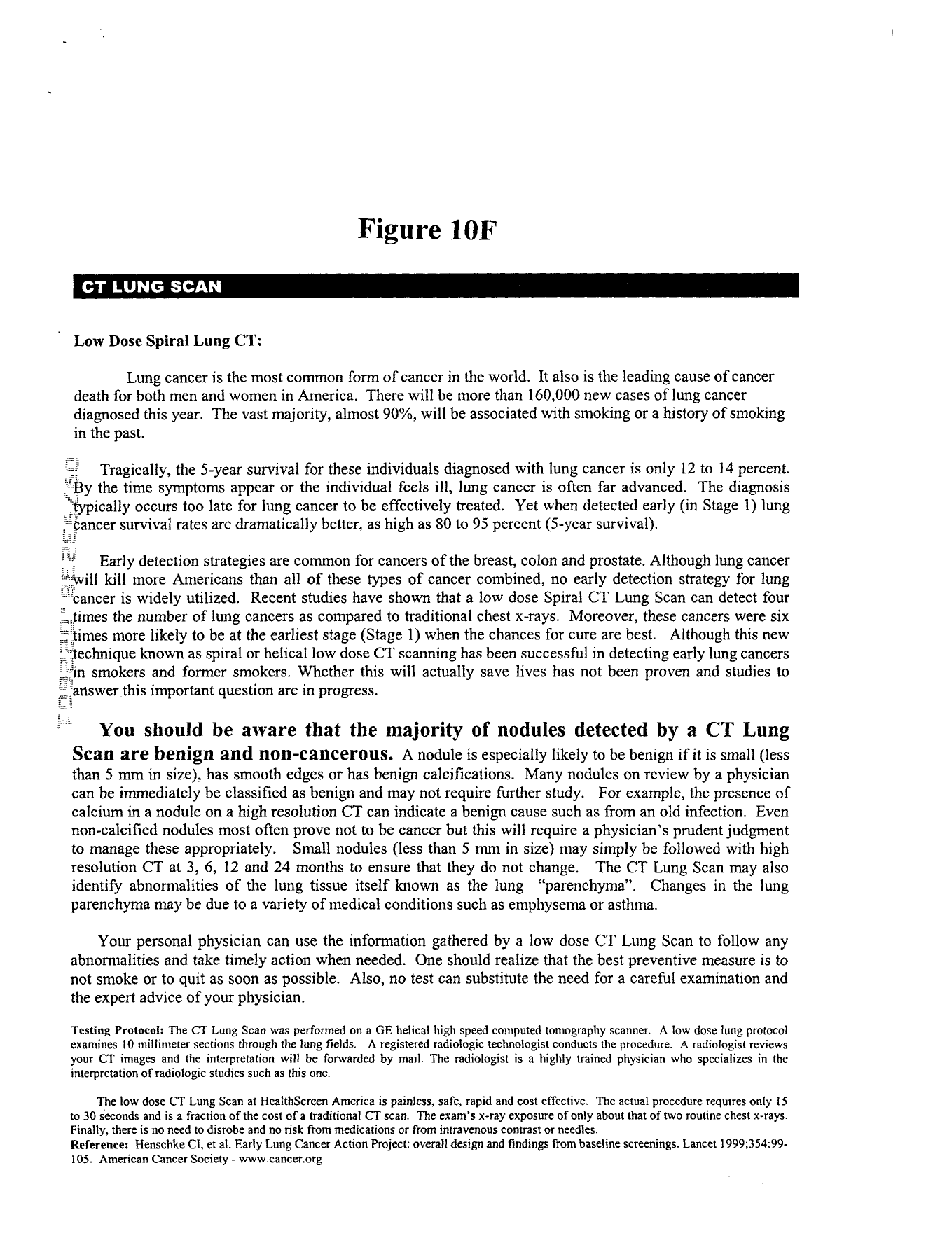

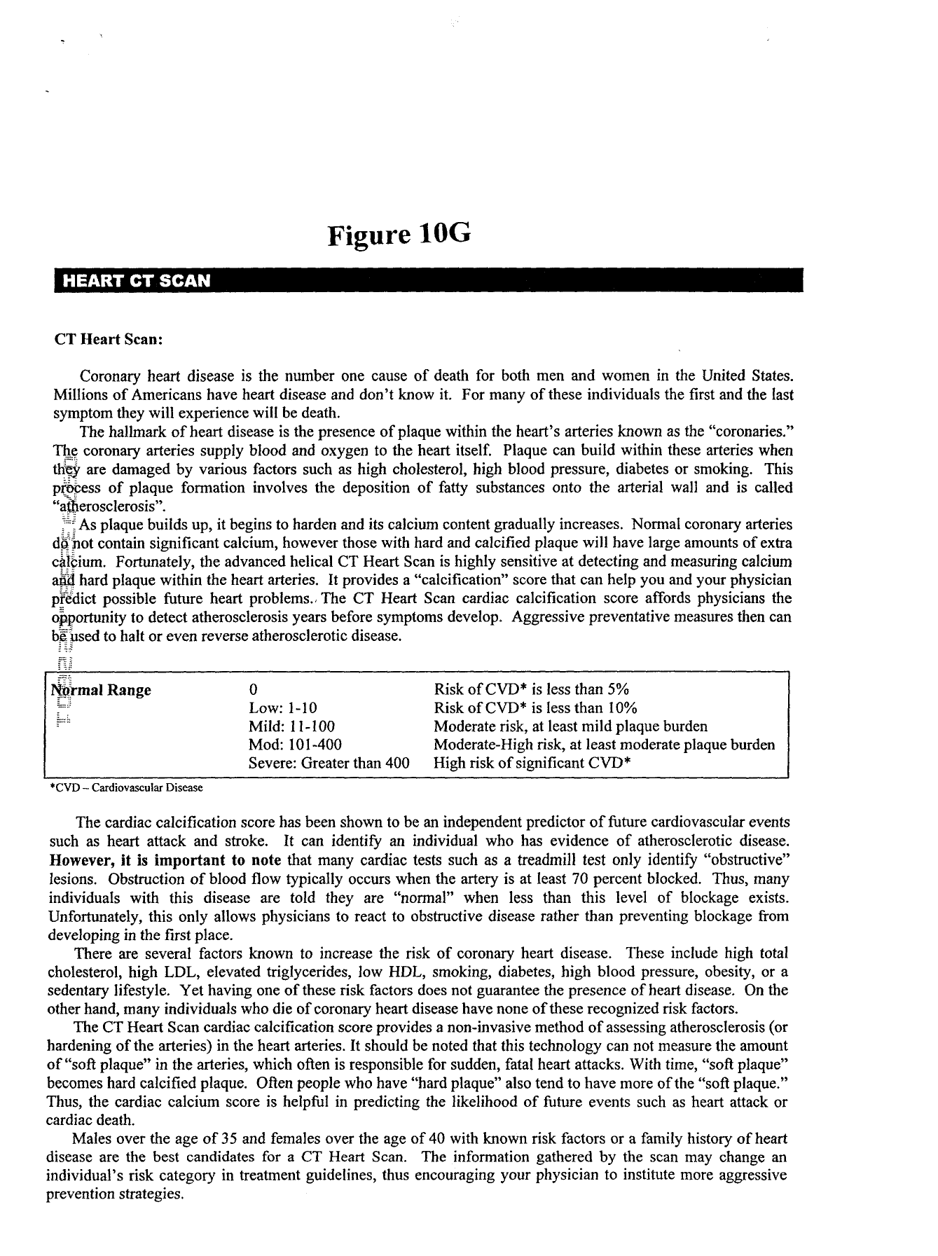

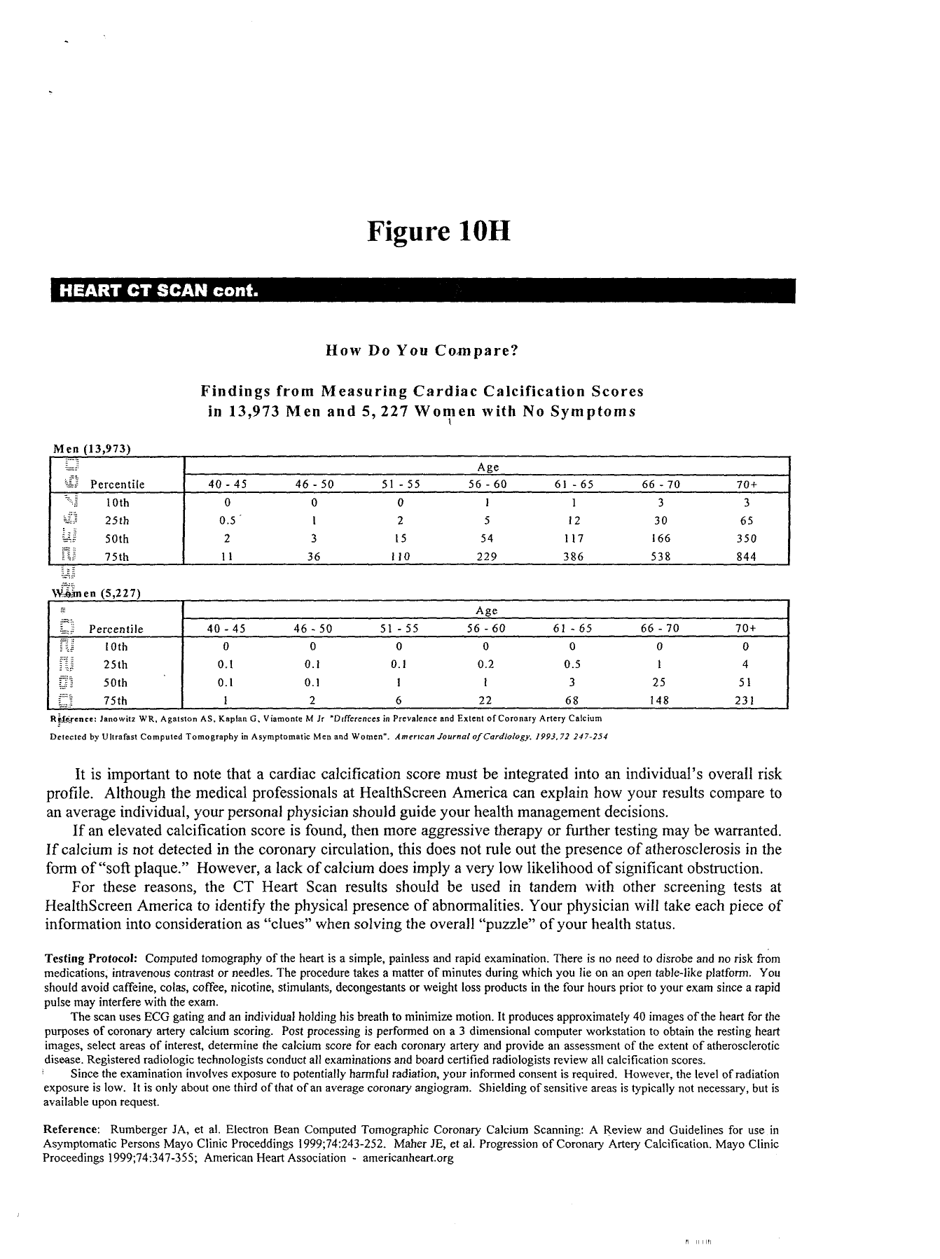

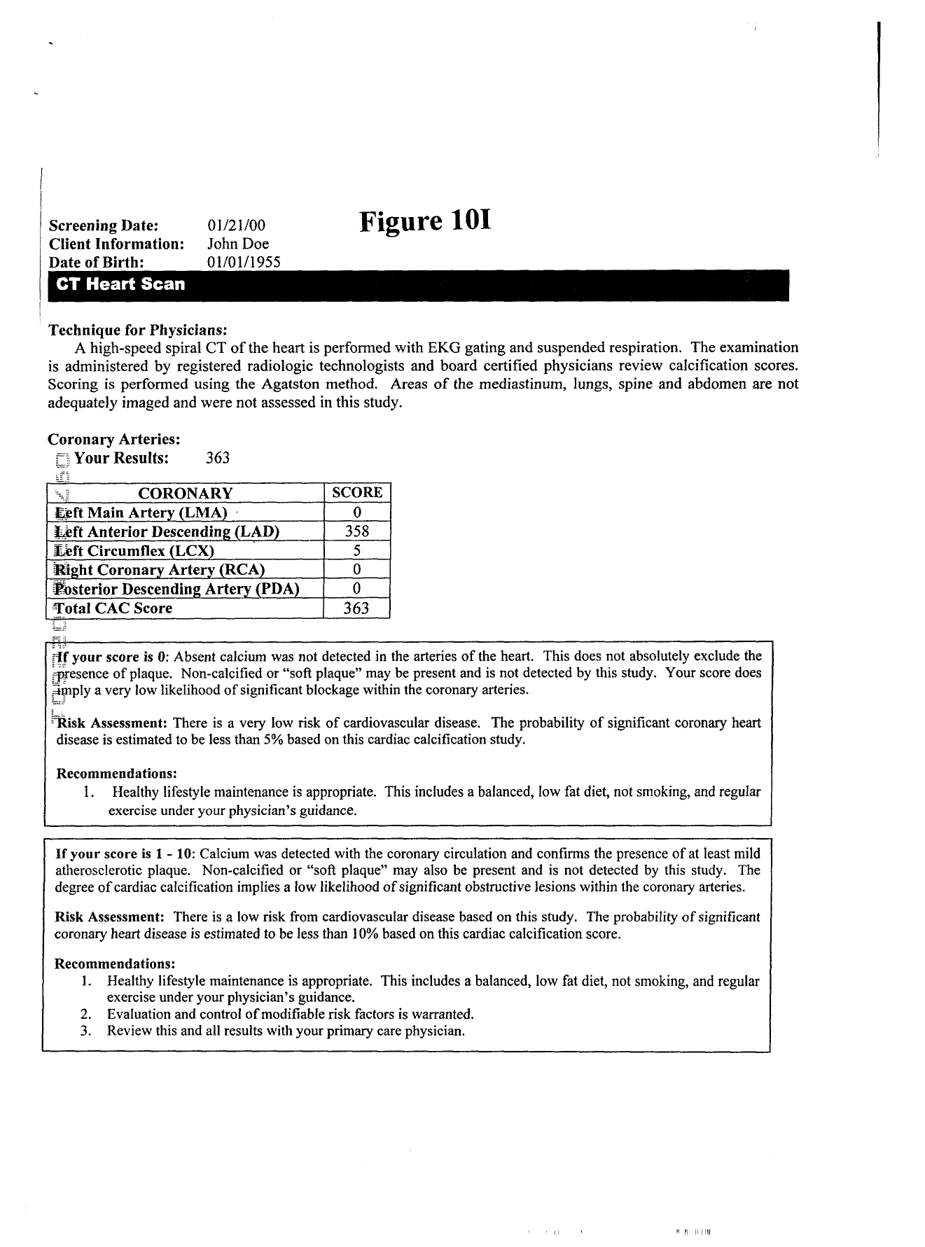

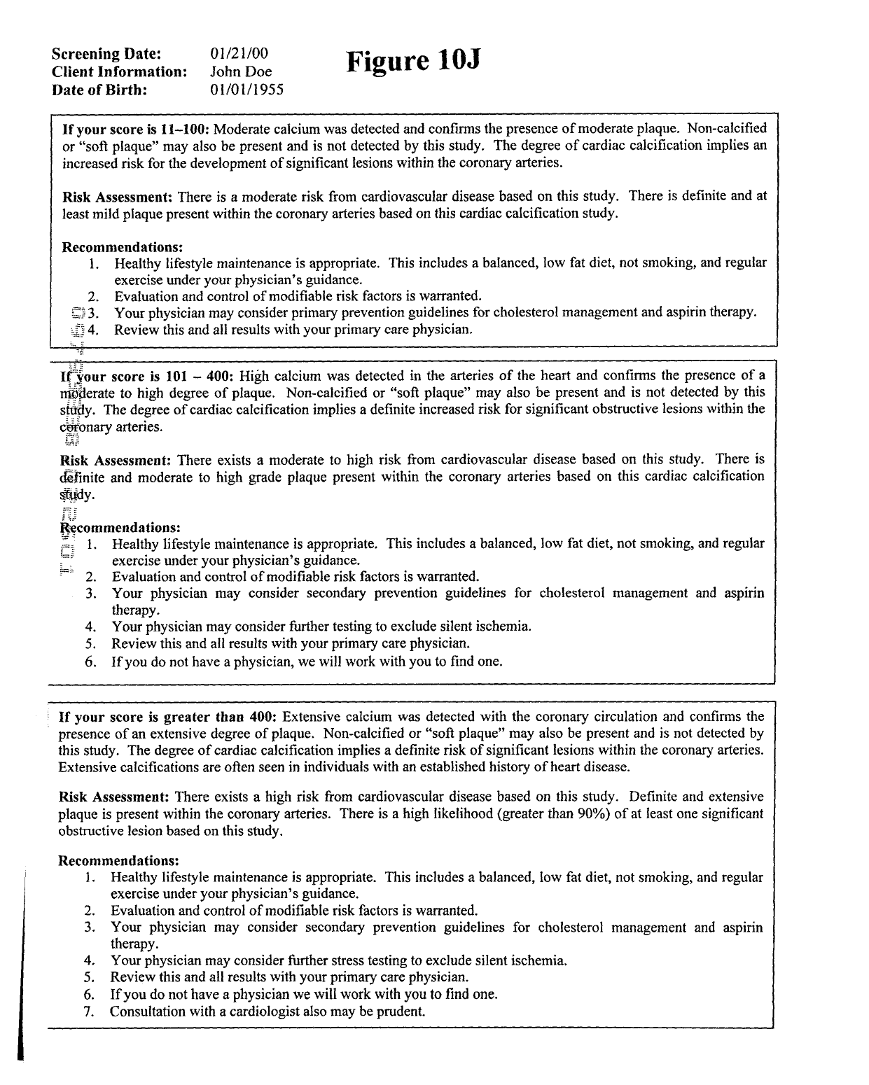

Because screening tests are offered directly to the consumer, educating the consumer to the availability and importance of early detection health screening is important. In the preferred embodiment, increasing consumer awareness is accomplished through a variety of methods, including participation in community-sponsored health fairs, marketing strategies and educational as well as scheduling information available on the web site which hosts the life-long health record, an example of which is shown in FIGS. 10A-10J.

II. Process Used with Individual Consumers and Organizations

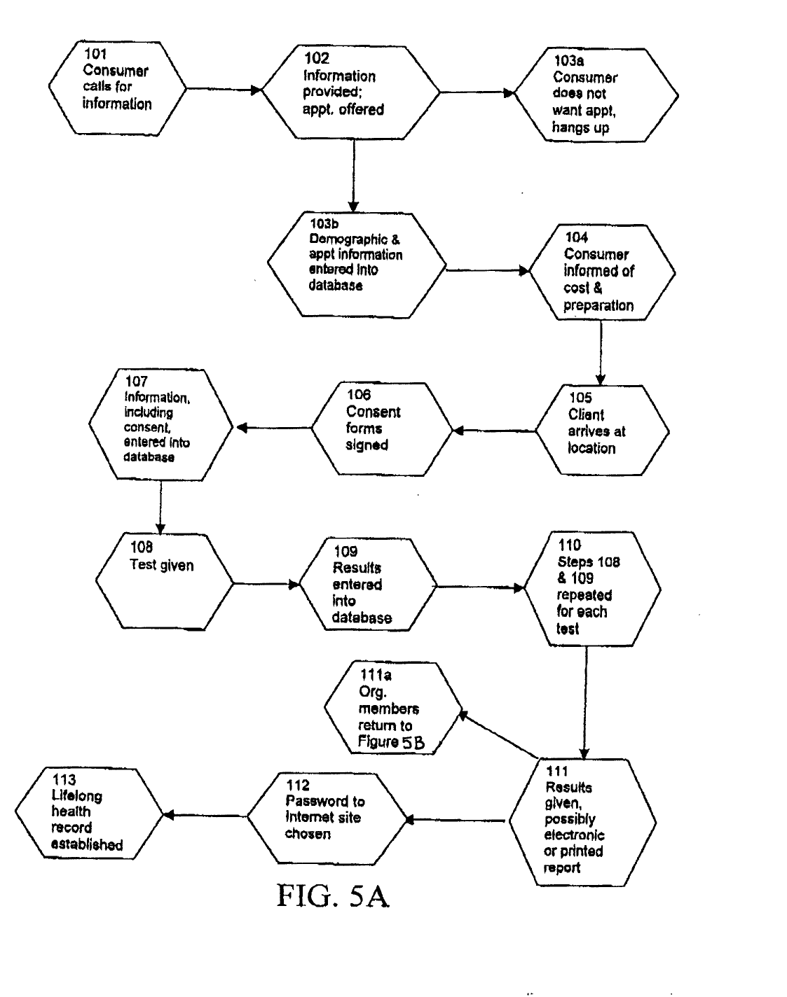

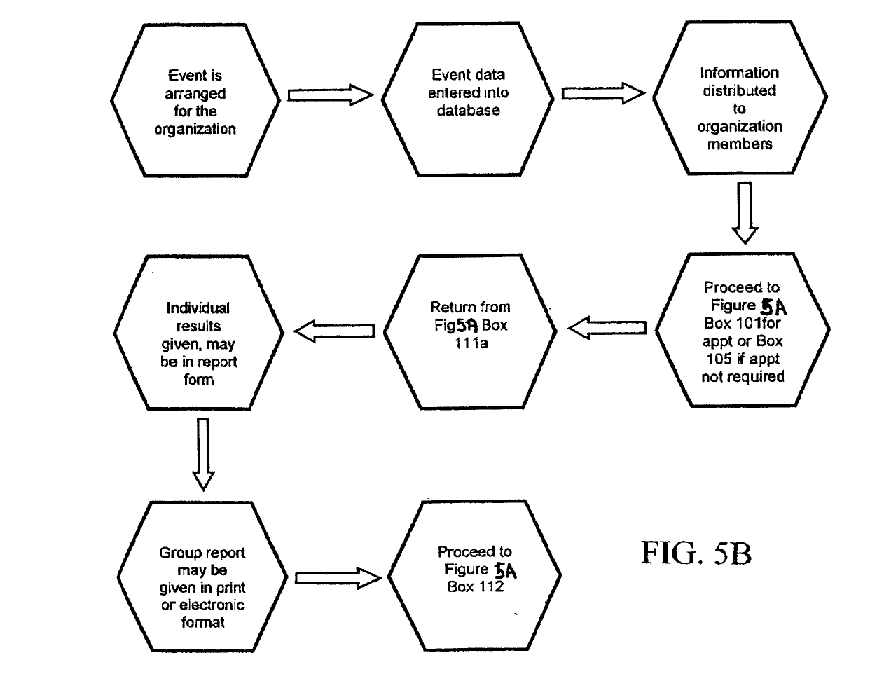

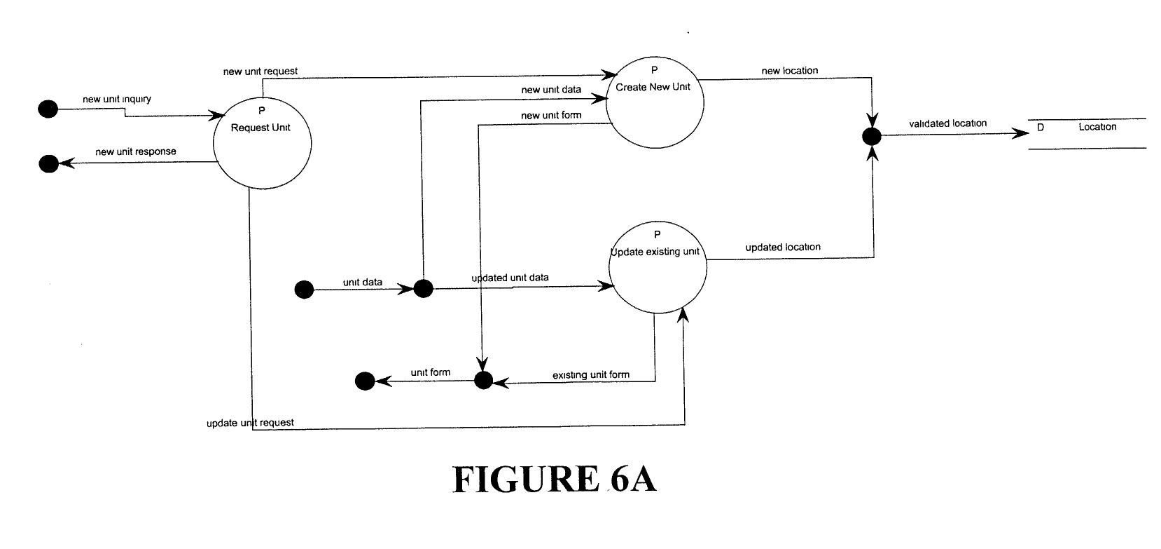

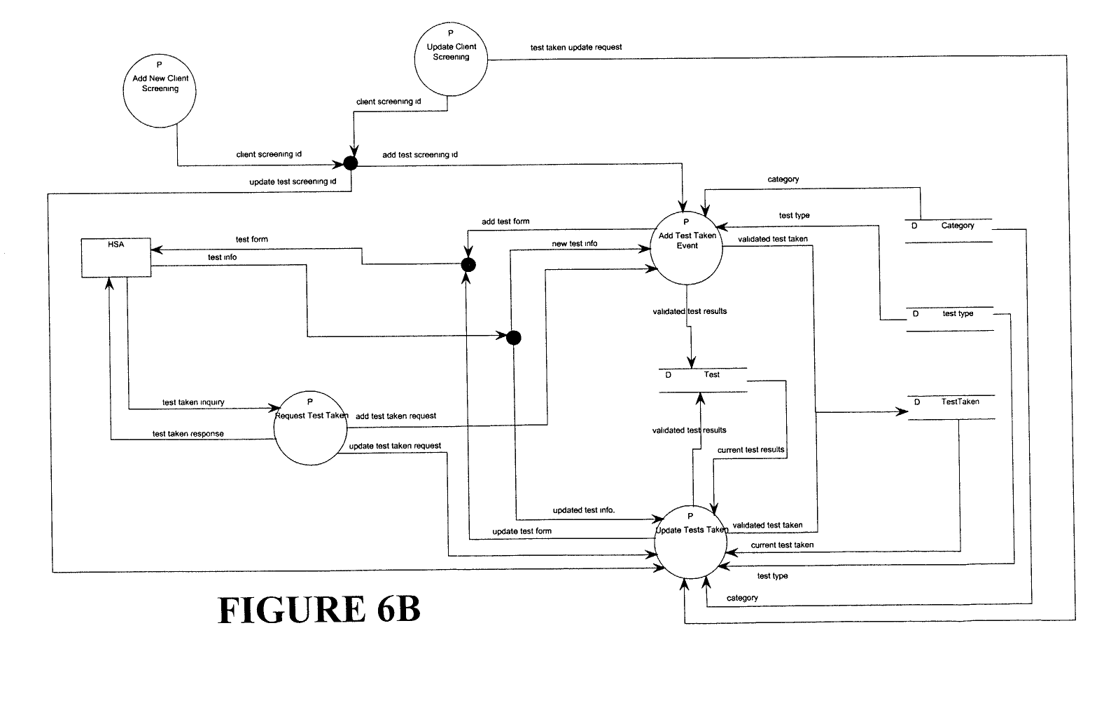

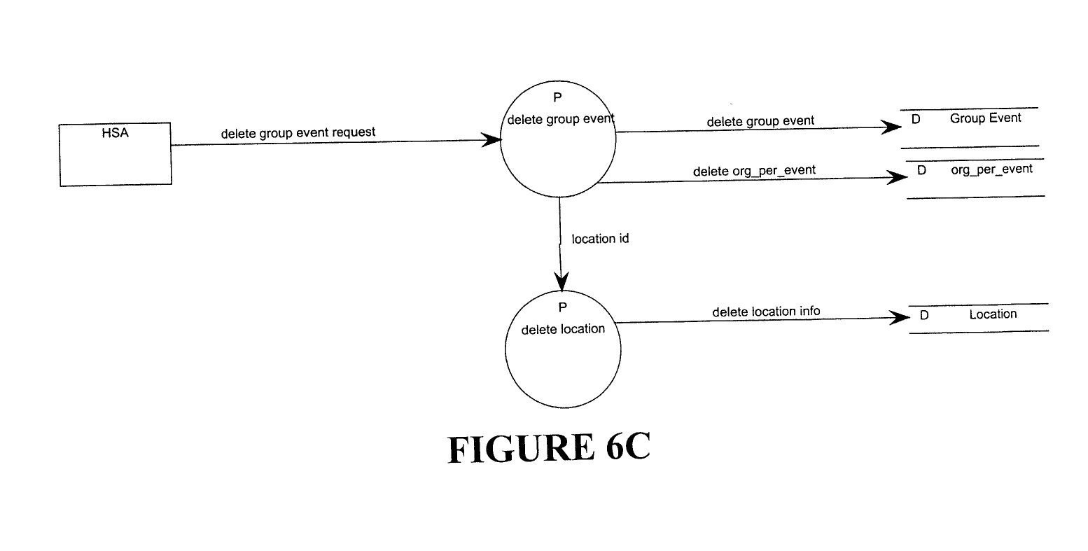

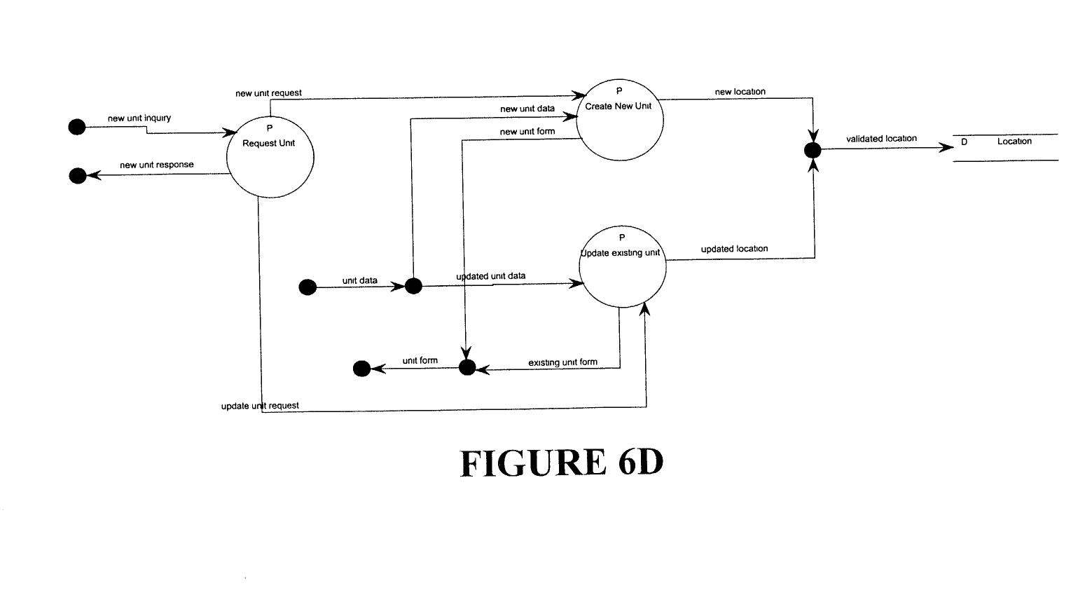

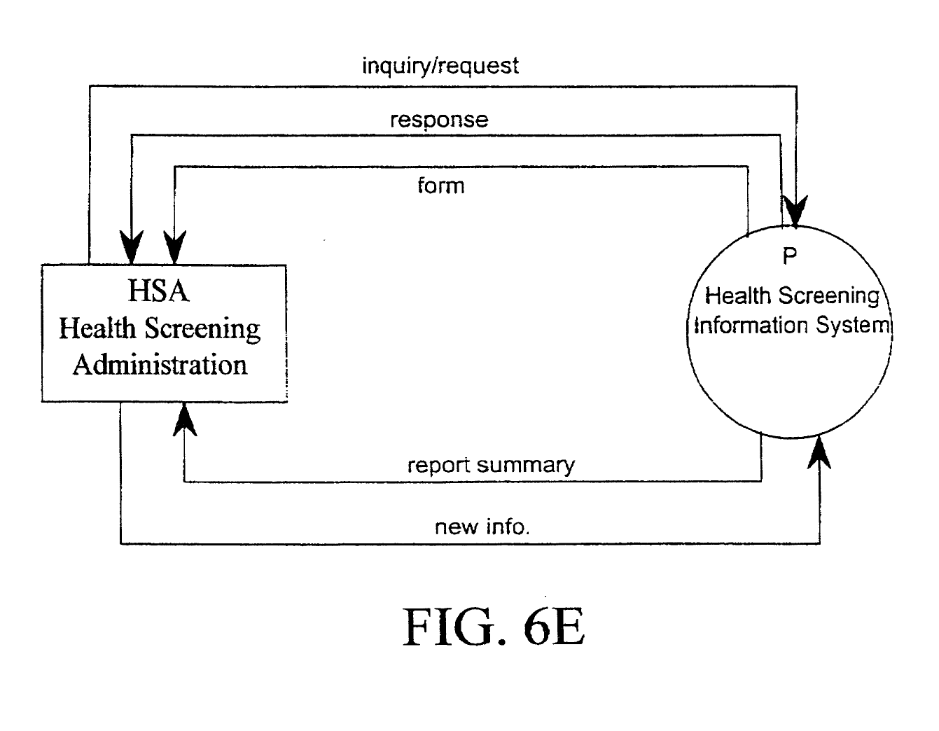

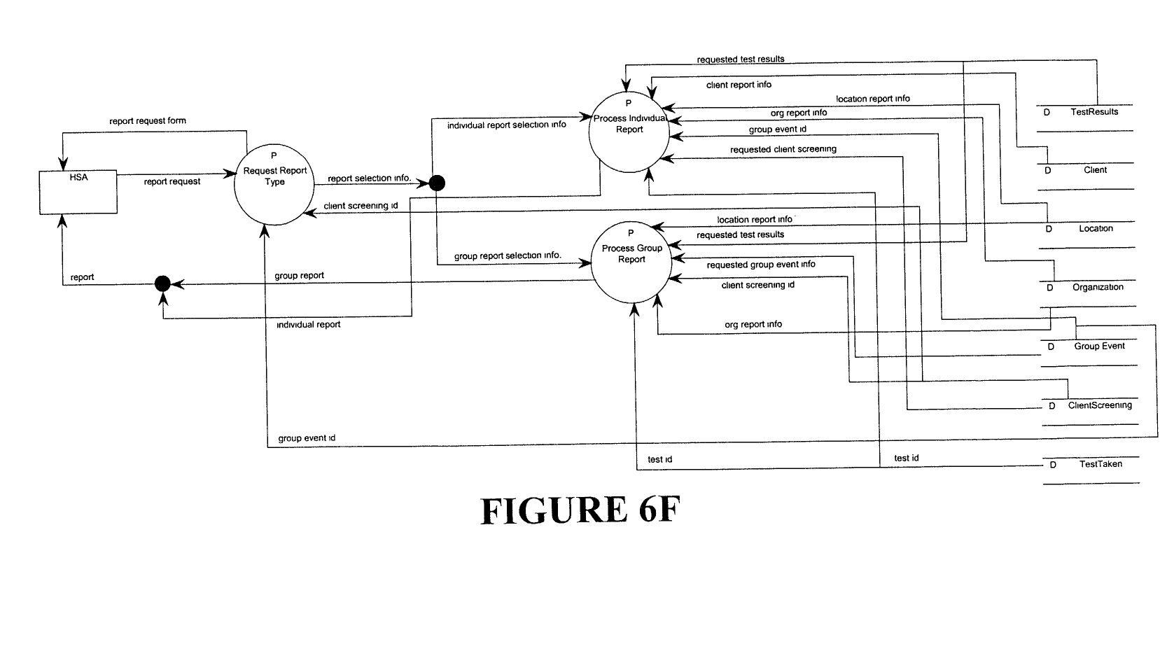

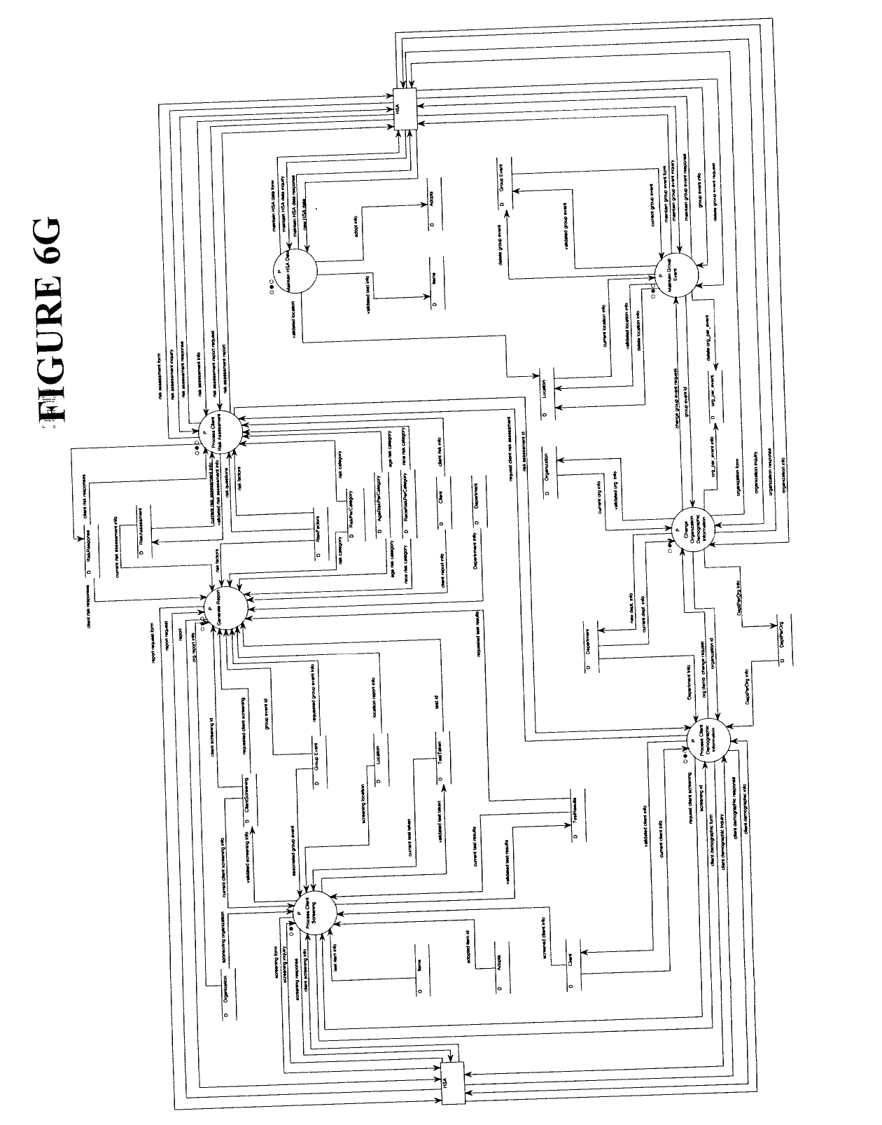

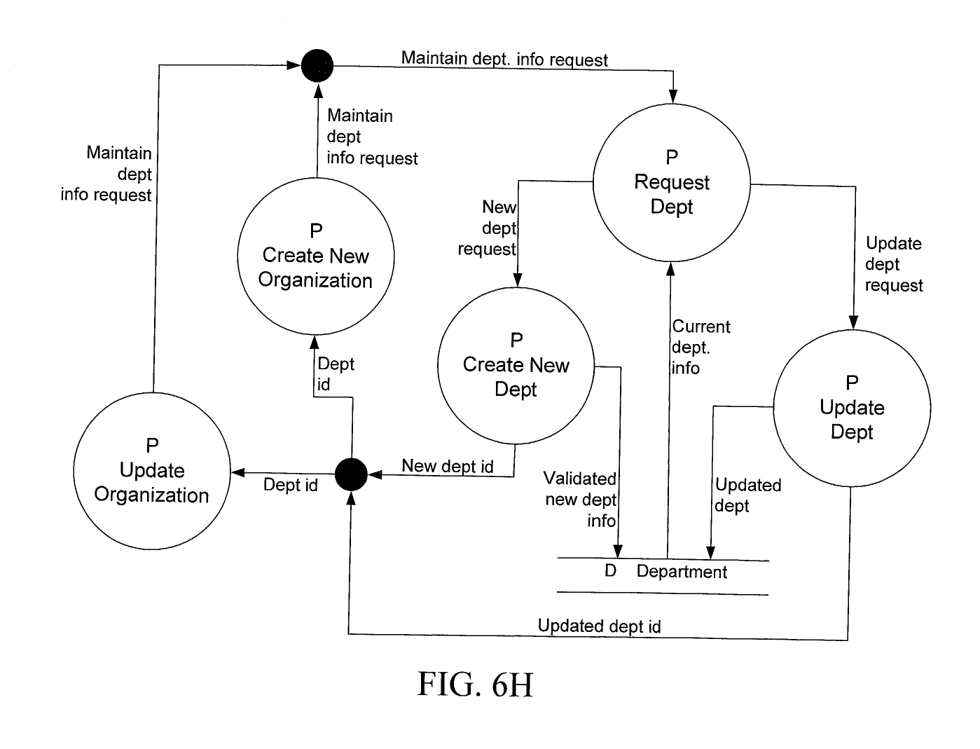

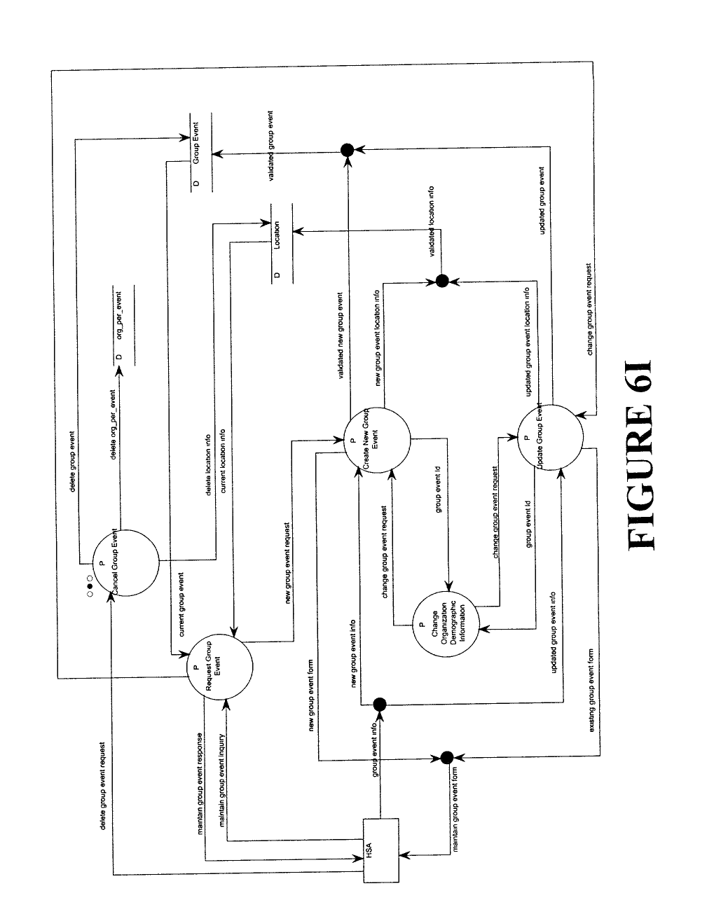

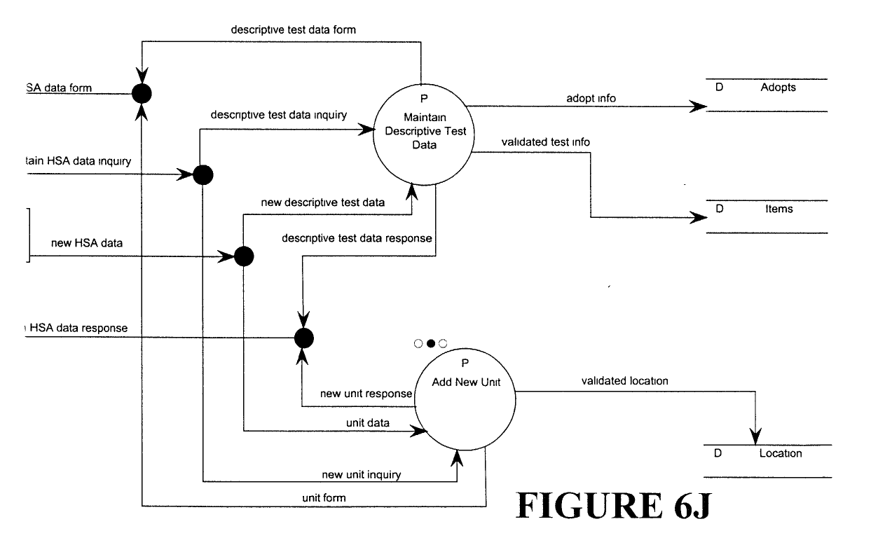

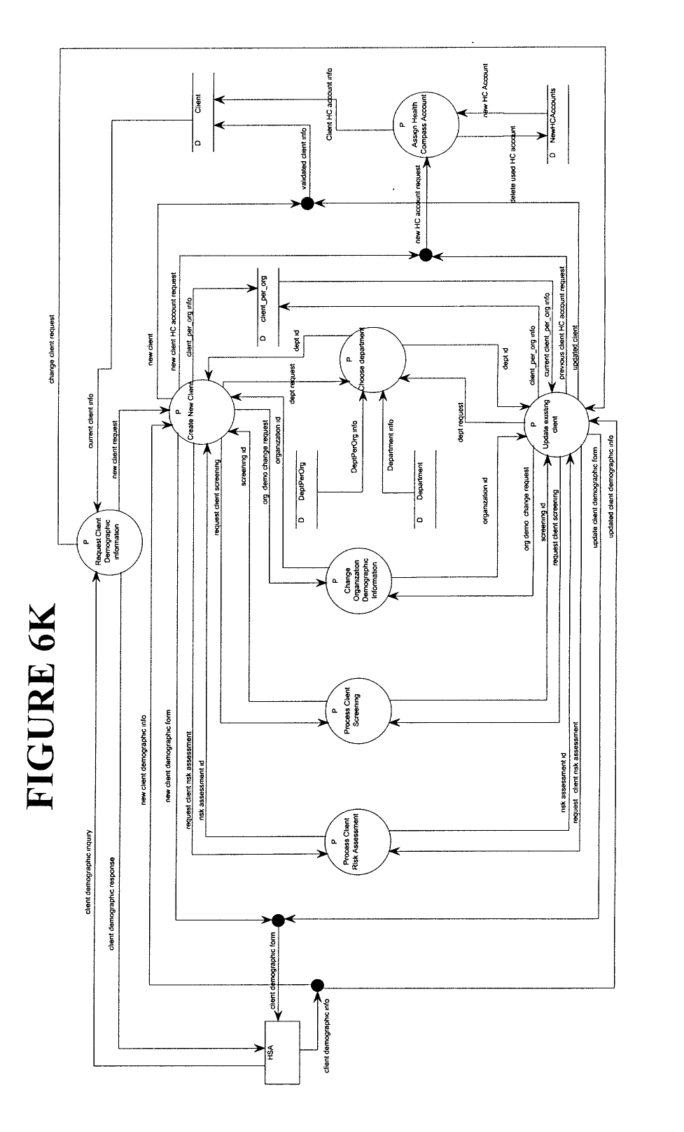

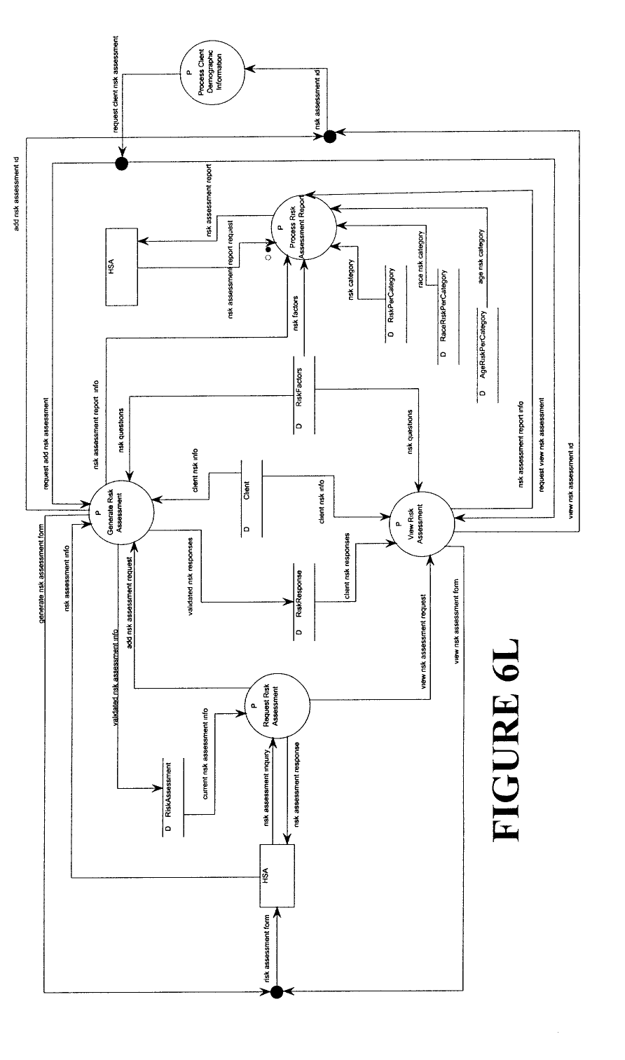

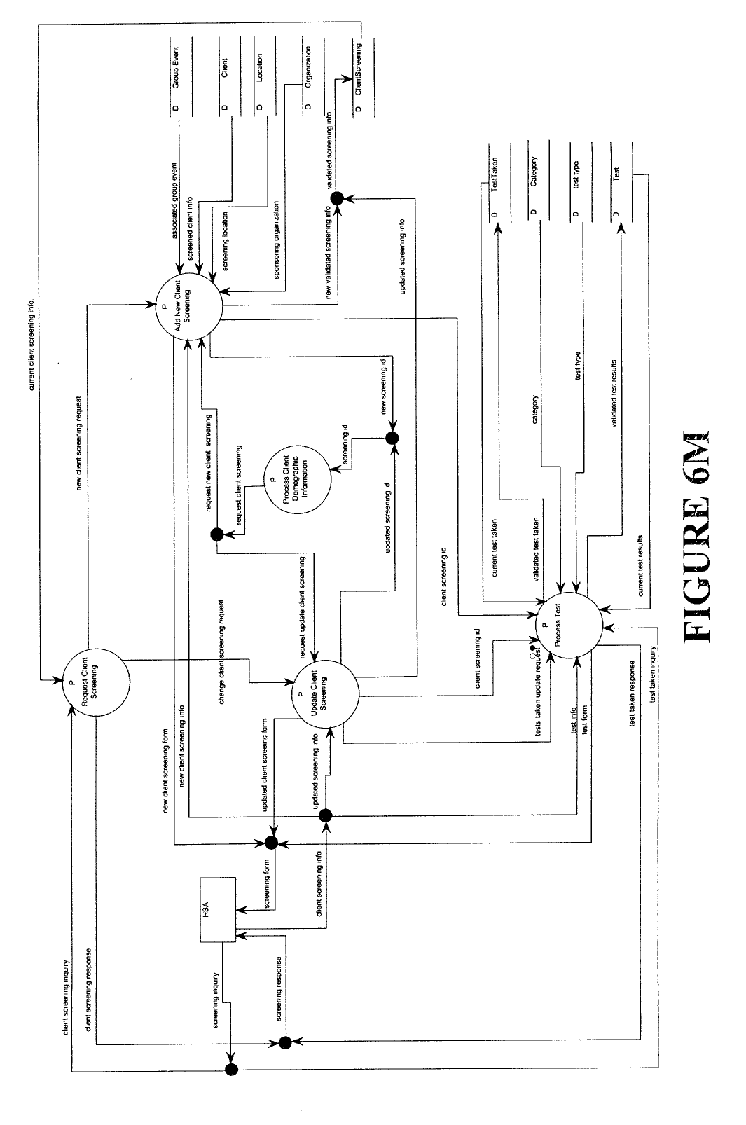

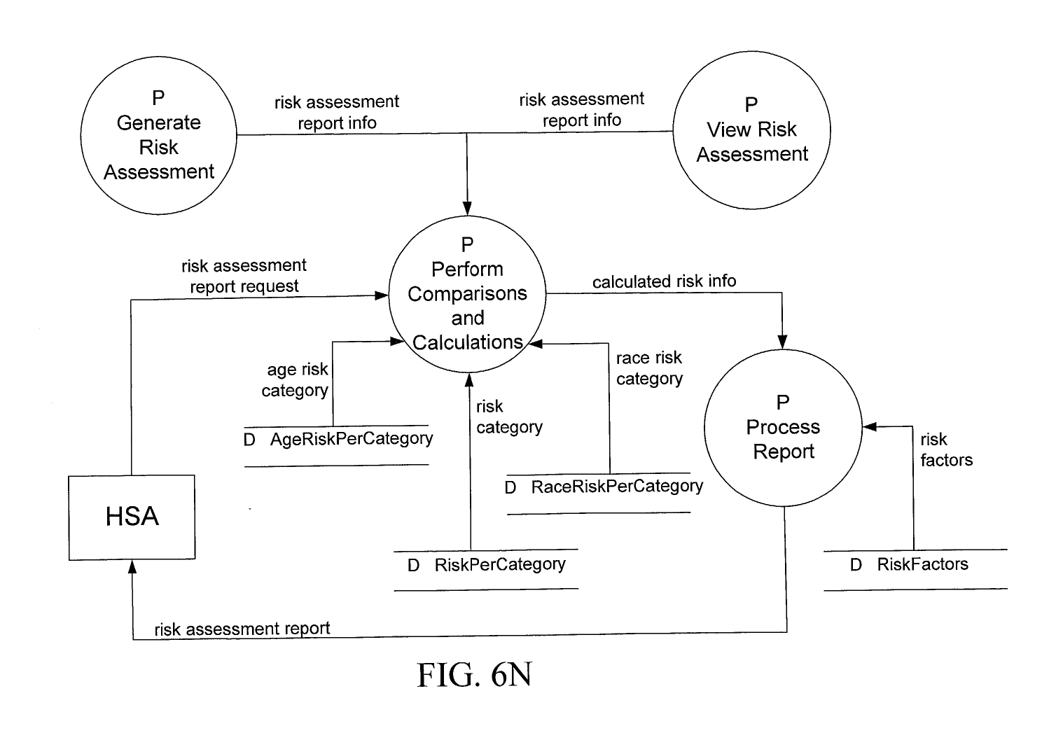

FIG. 5A is a flowchart showing the process for the individual with sub chart, FIG. 5B, showing the process when an organization is sponsoring or hosting the health-screening event. Individual consumers call to obtain information and make an appointment. The individual's demographic data is entered into the database along with the time, date and location of appointment and the tests or test package desired. The cost is automatically figured and the appointment maker goes over the cost and any preparation needed, such as four hours of fasting for the glucose test. An alternative scheduling method could be offered at the web site wherein consumers could schedule appointments for health screening tests through a secured connection over the Internet.

FIG. 5B starts with the booking of the event for the organization. All pertinent information is entered into the database, including time, date, location, tests or packages offered. Organizations can choose one package for each member or employee at a discounted fee or may choose to let their members or employees choose the tests desired. Responsibility for payment is also noted in the database as some business organizations fully cover the costs of the program for their employees under wellness plans. Health screenings can also be booked as events when a public organization, such as a local school or health department, wants to hold open house health fairs. Generally, no advance appointments may be needed when public organizations host health fairs. Types of tests given at health fairs may be limited to basics such as blood pressure, cholesterol readings, and vision/hearing screenings. Often, cost is nominal or free. In those cases, the event is entered into the database, so that data can be entered and tracked on the day of the event.

Upon arrival at the location, both individuals and members of organizations are asked to sign consent forms. The consent forms preferably consist of four sections:

(1) consent to take the tests;

(2) consent to have the results posted on a secured, privacy-protected life-long health record accessible with a web browser;

(3) consent to receive information in electronic and/or printed formats; and

(4) consent to let their data be anonymously used in a statistical database to help forecast health trends and assess risk factors among a largely a-symptomatic population and to be informed of clinical trials and experimental treatments that may pertain to them, according to their test results.

In the preferred embodiment, all four consents would be given, but clients are given the tests as long as they sign the first portion of the consent form. Information including which consents were given and the date signed is entered into the database prior to any tests being performed. As a safeguard, the program is designed to prevent any further action being taken until the consent information is entered. At the point the consent information is entered, the computer automatically assigns a unique identifier to the client. The use of this identifier increases security. Many consumers are concerned that insurance carriers or employers may use information about health risks to deny coverage or employment opportunities. Avoiding the use of easily traceable numbers, such as social security numbers, helps maintain the consumer's right to privacy. Each time a client comes in, the consent forms are reviewed, and any changes noted.

The client is taken to the testing area where the procedure is explained in detail by the technician. The test is performed and the data is entered into the database in the most error-free way possible. In the preferred embodiment, the data is not entered by data entry personnel but by direct entry from the equipment or a smart card-type device. To further increase accuracy, additional accuracy checks may be instituted on a regular basis. For instance, another member of the facility staff not involved with the consumer's screening test may review the test results to certify that the results were entered correctly. In the preferred embodiment, two additional accuracy checks are routinely made to ensure the data is correct to the greatest degree possible. Such direct entry and accuracy checks avoid the risk of human error, such as reversing digits, and ensures a higher degree of accuracy.

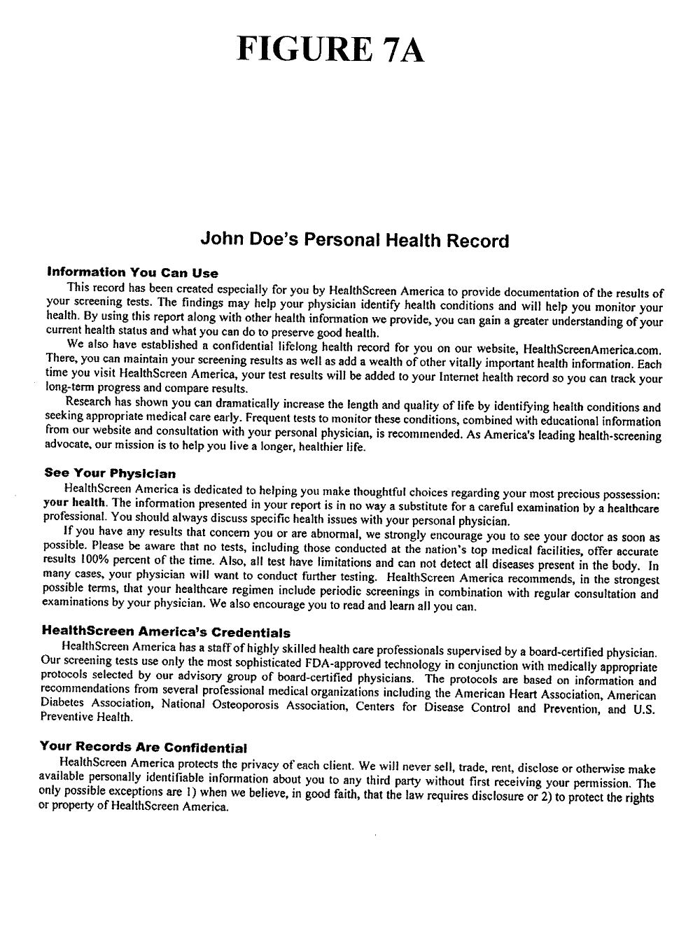

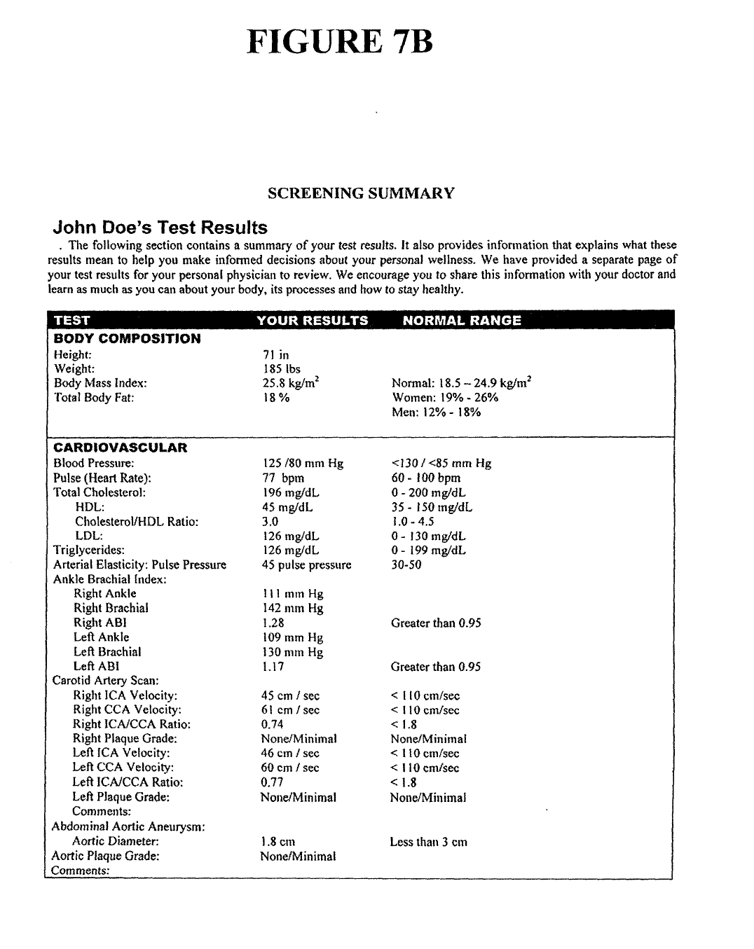

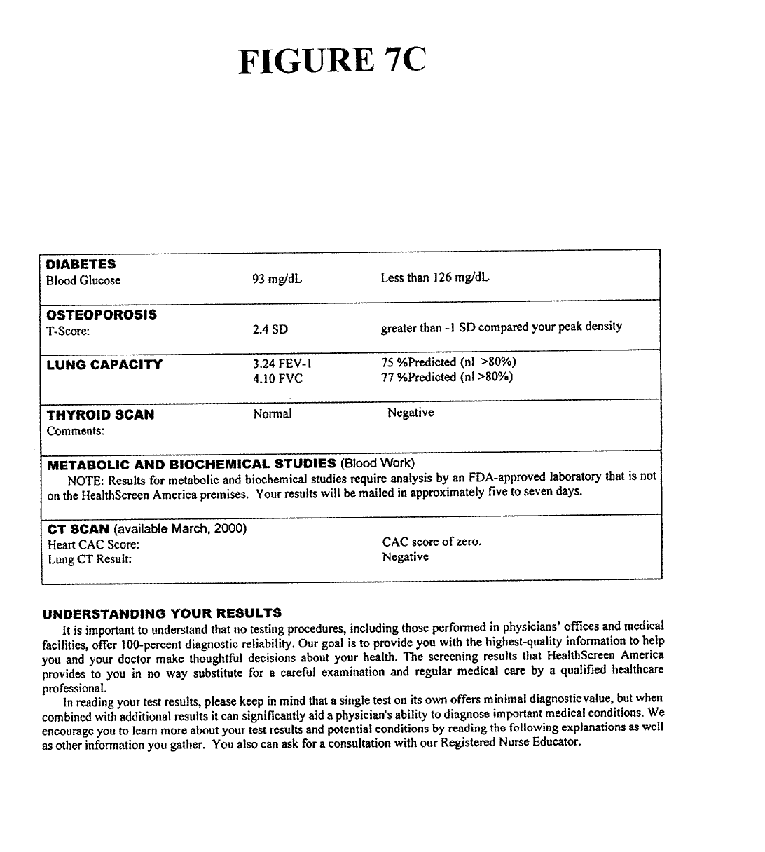

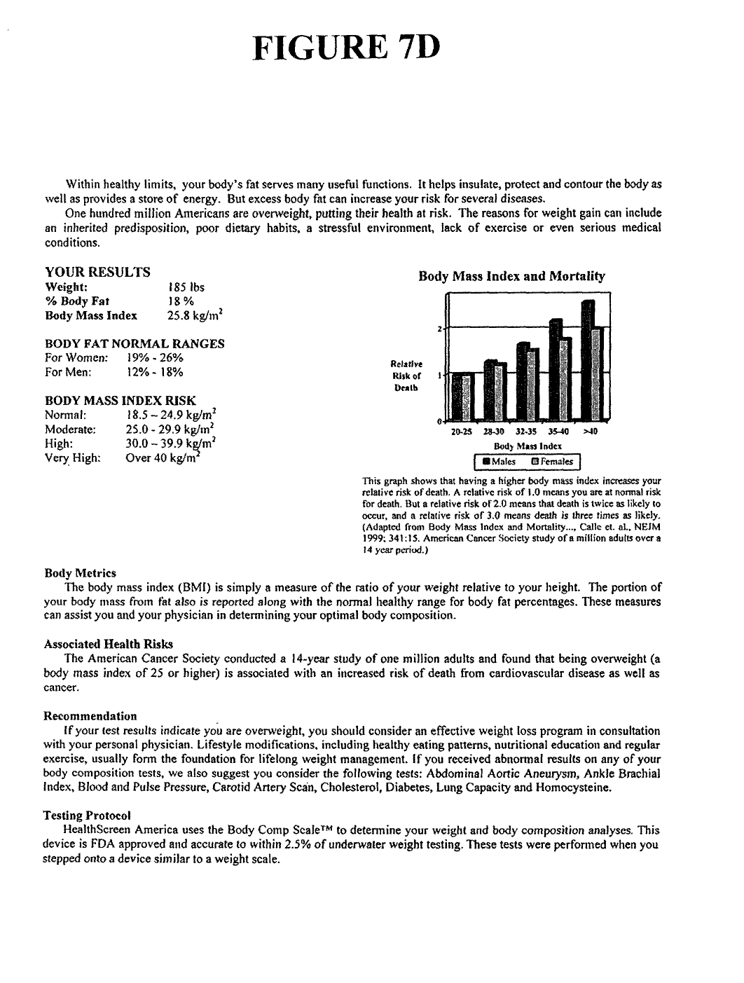

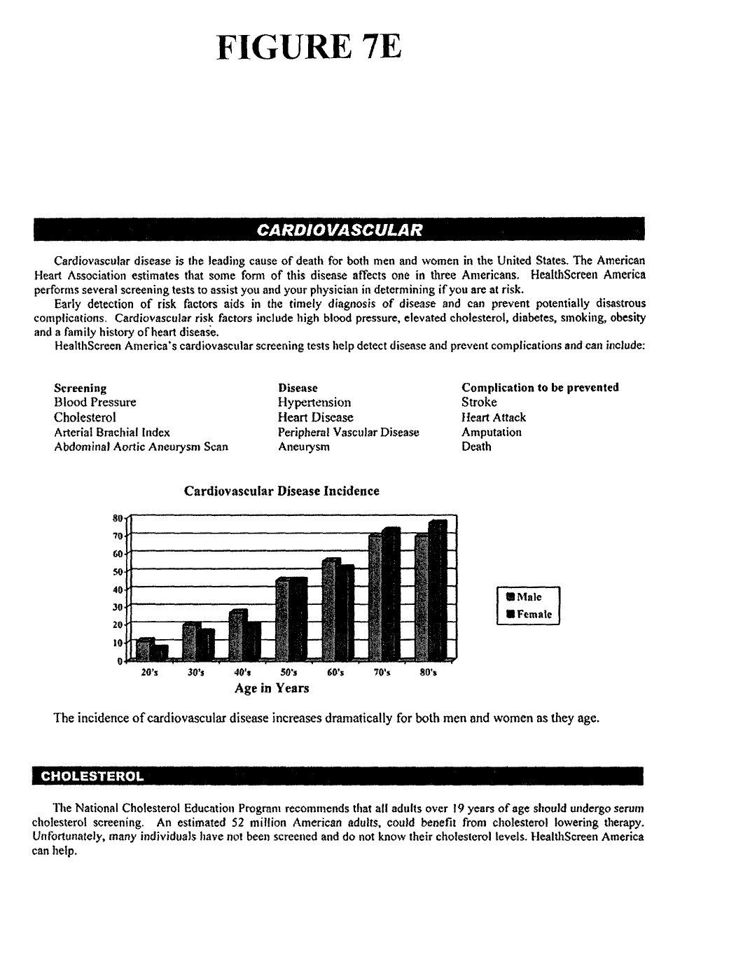

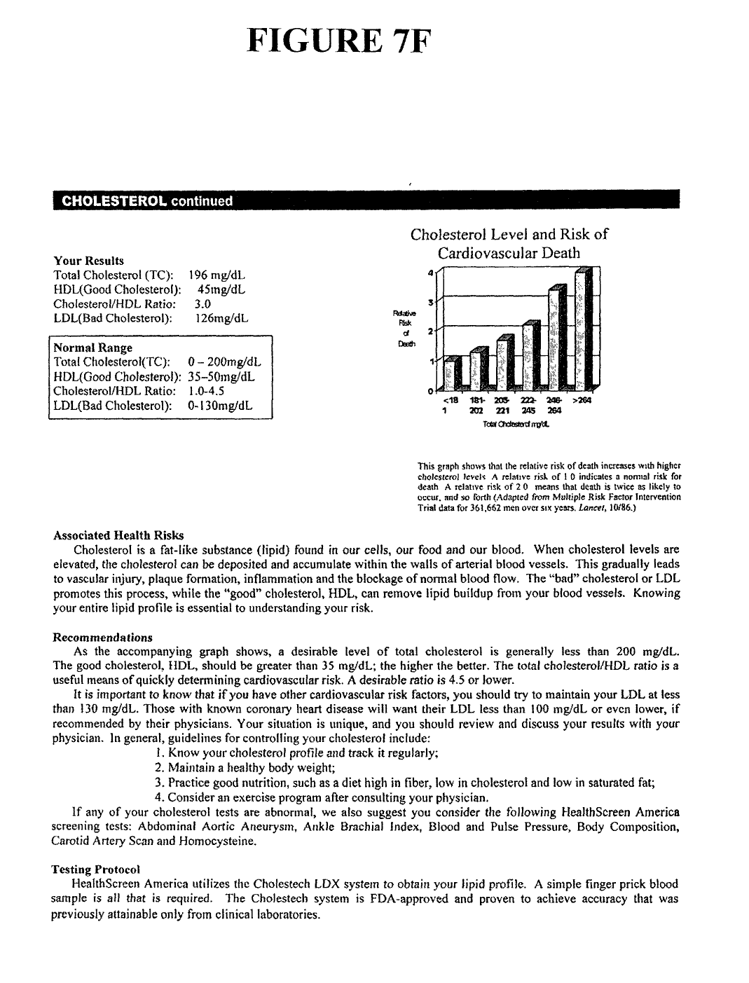

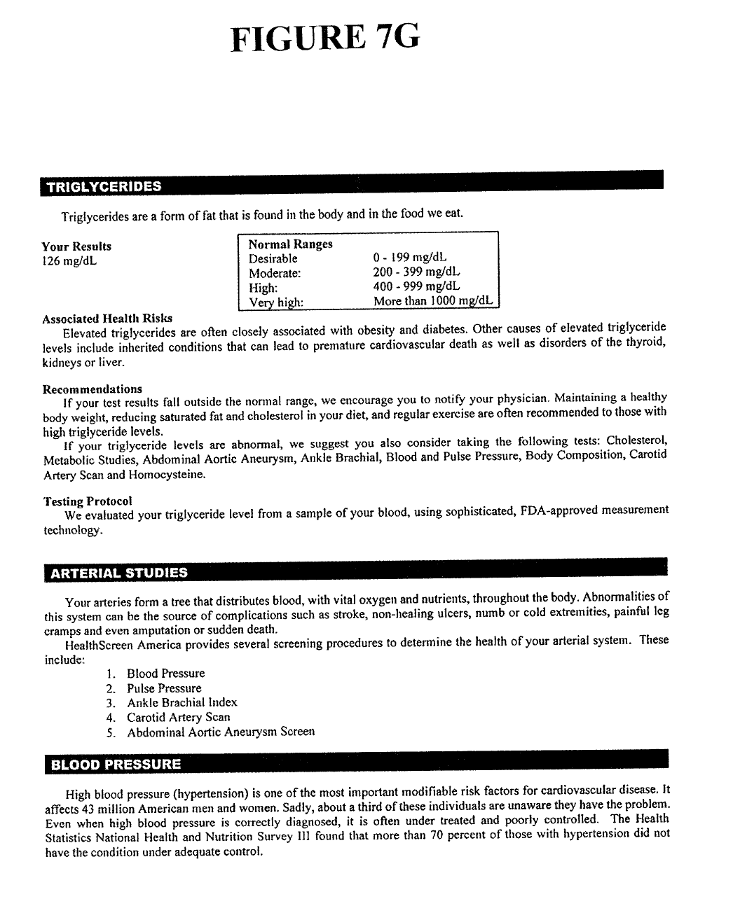

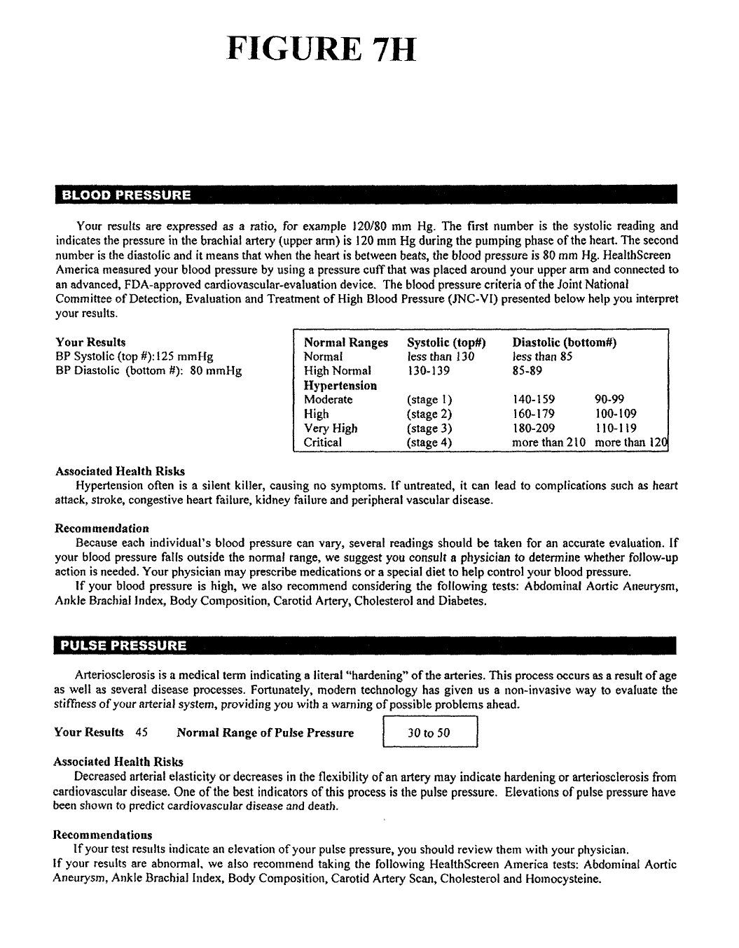

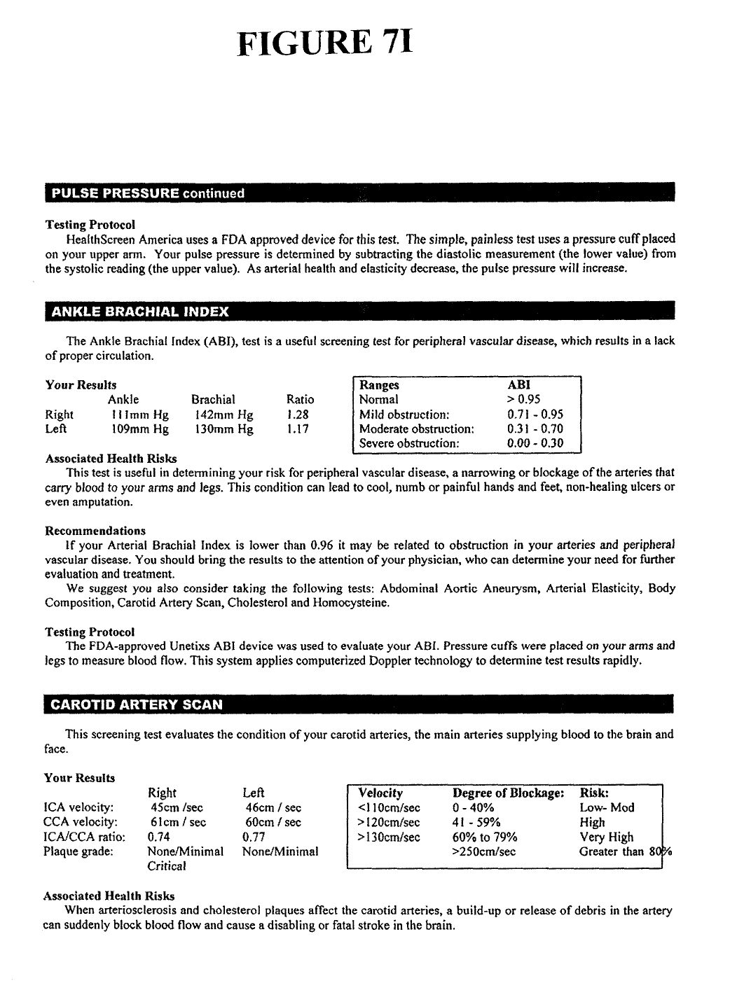

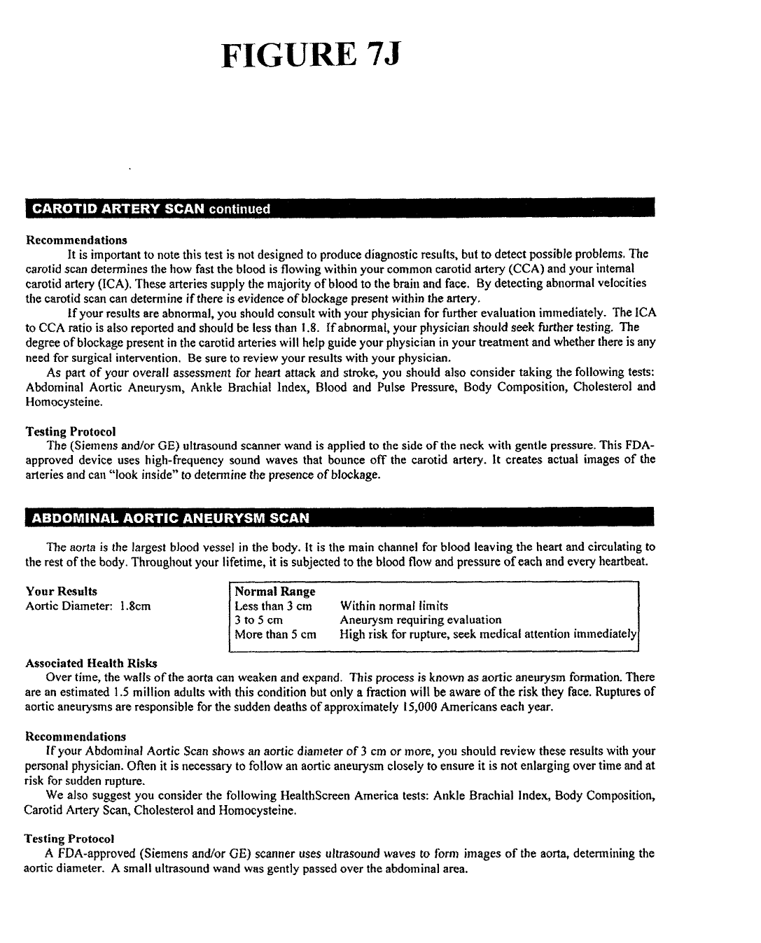

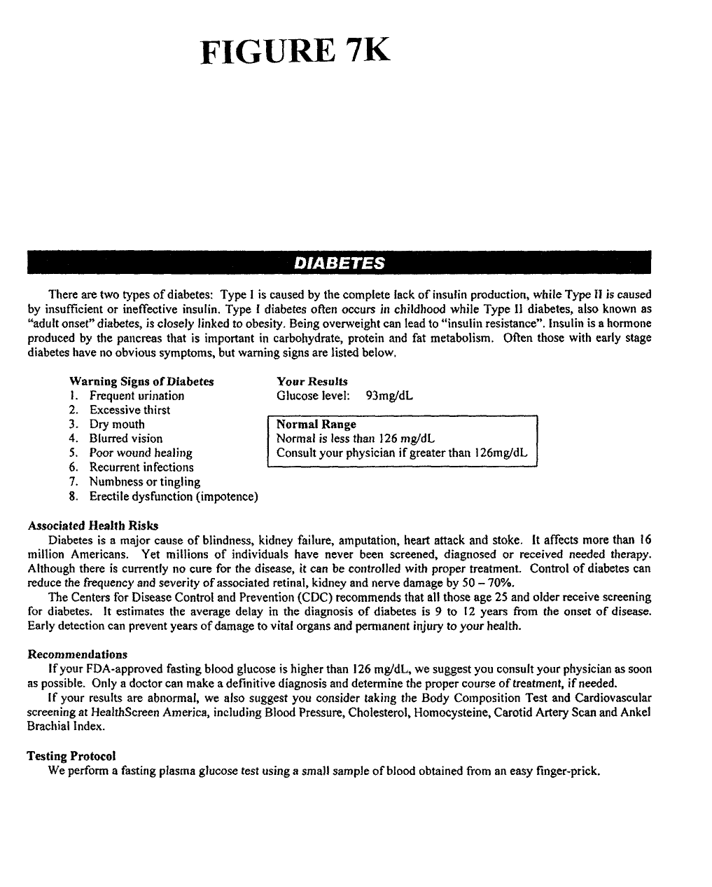

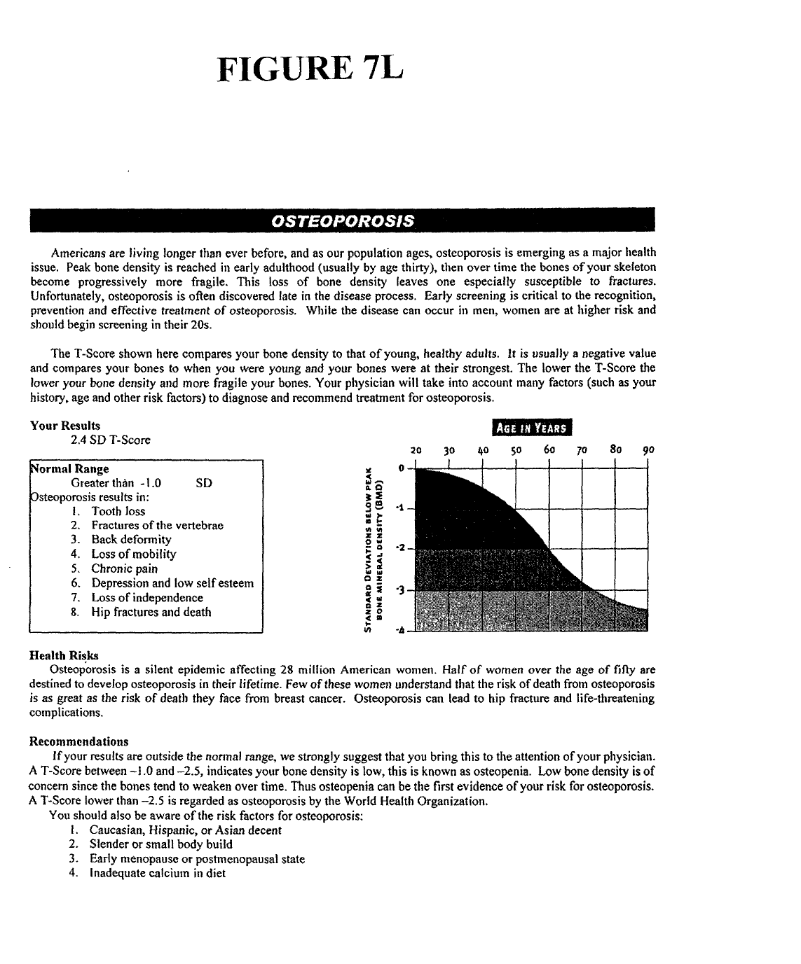

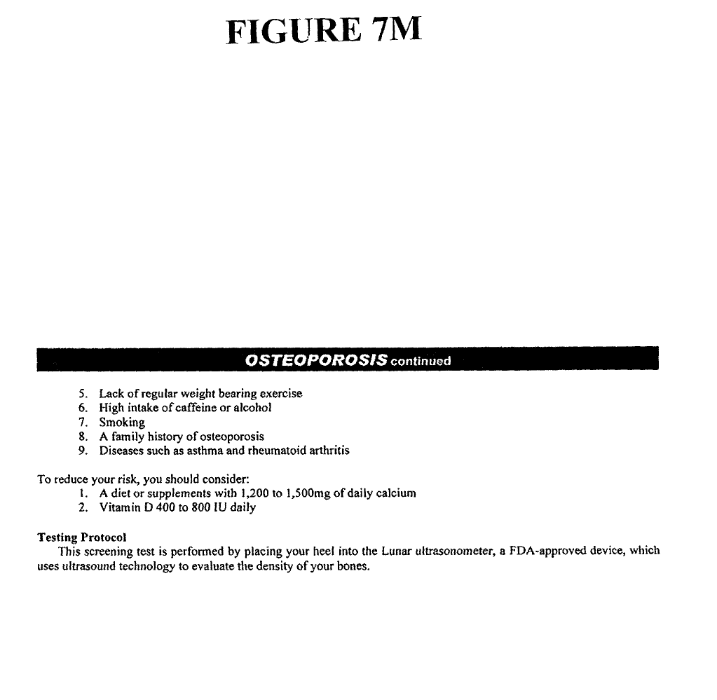

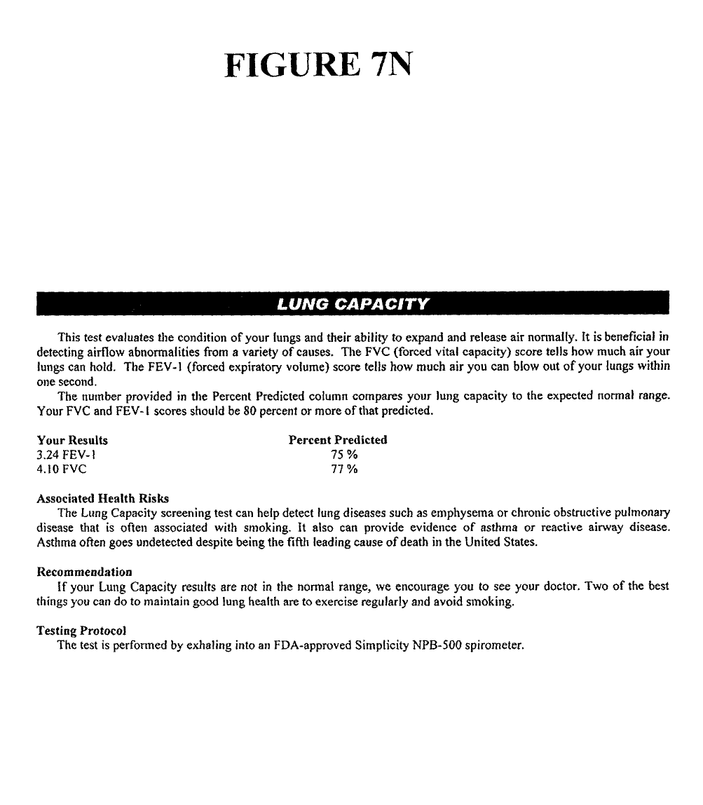

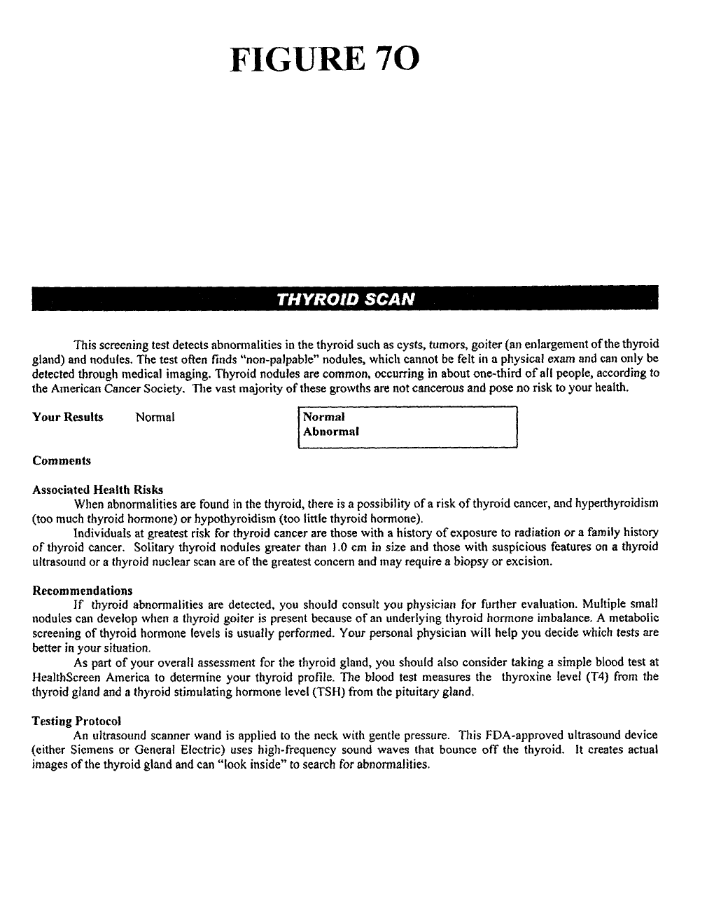

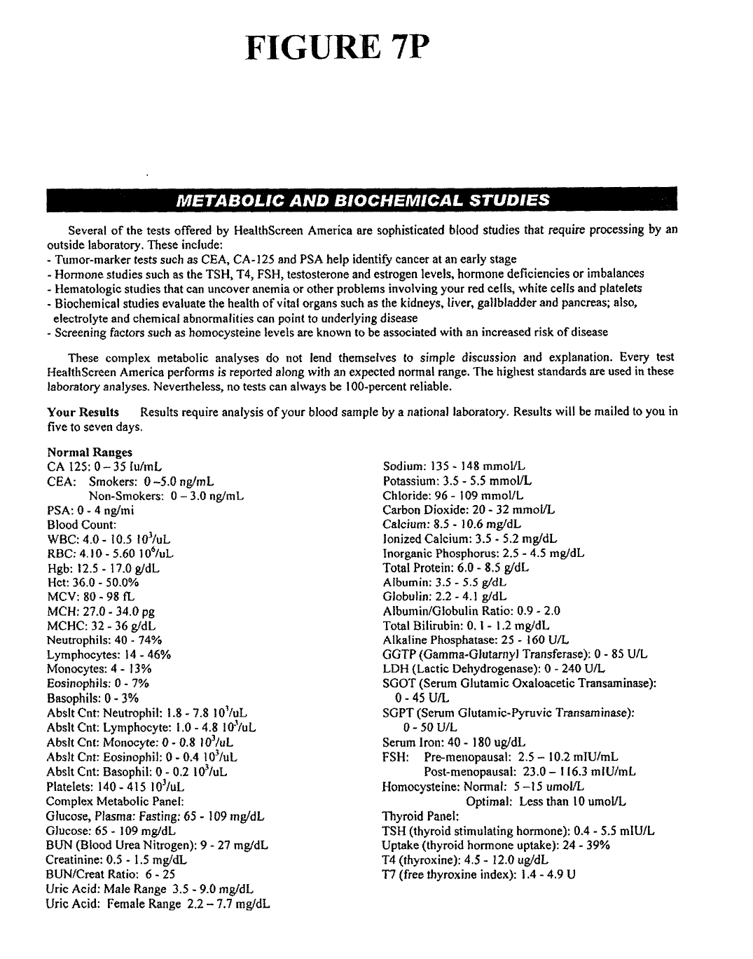

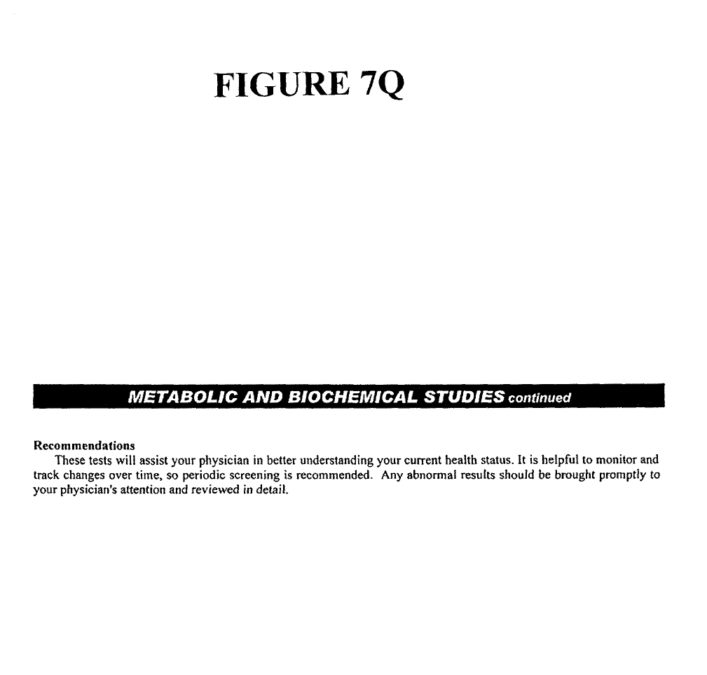

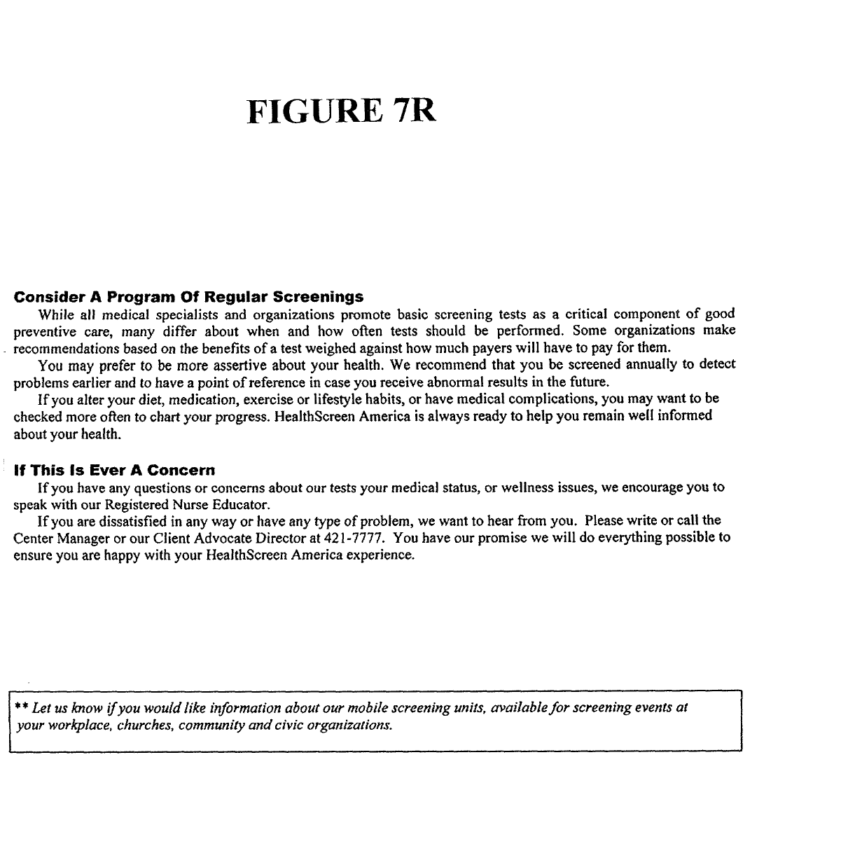

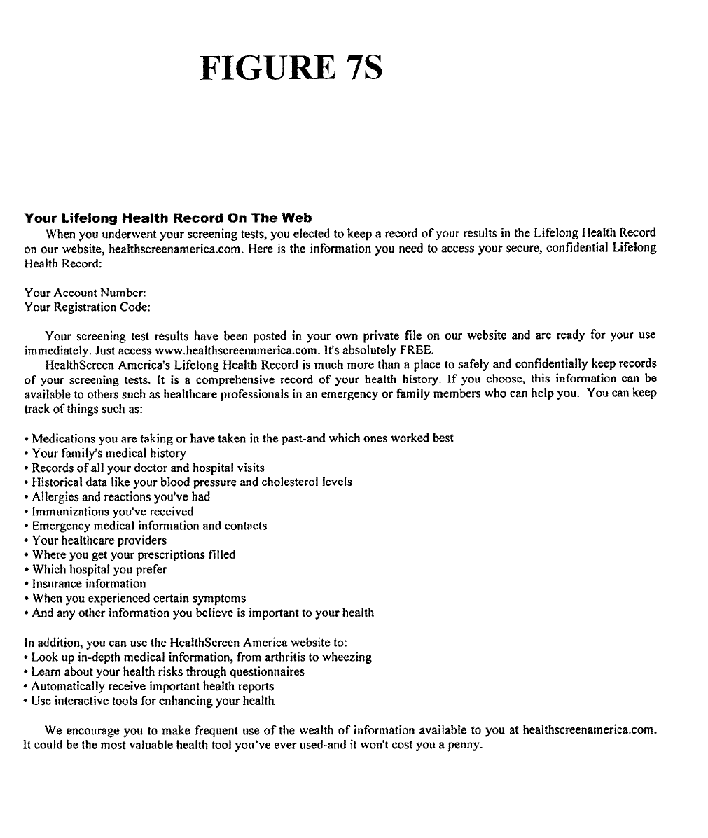

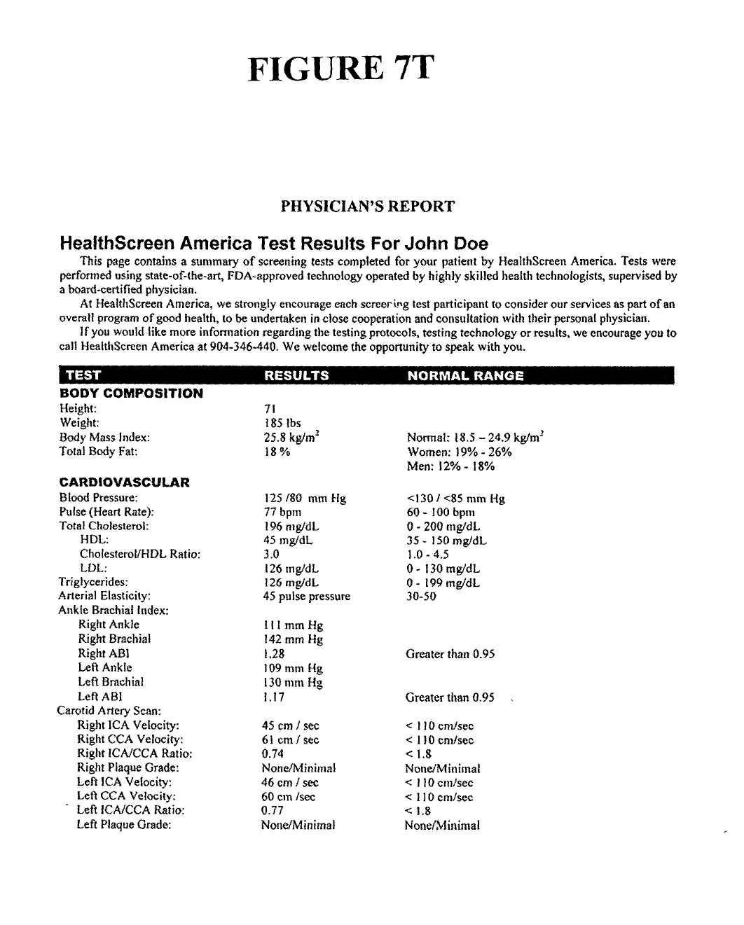

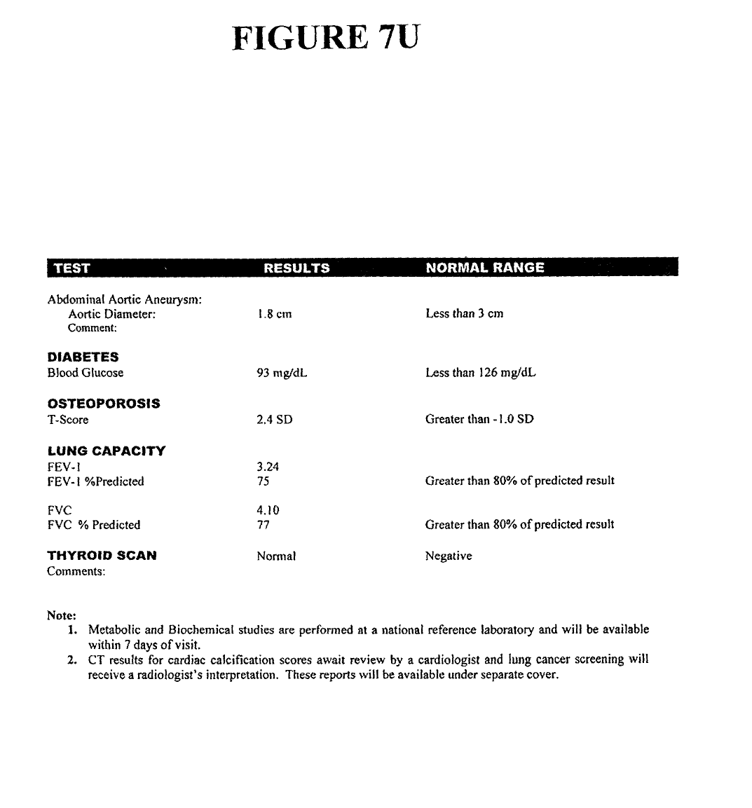

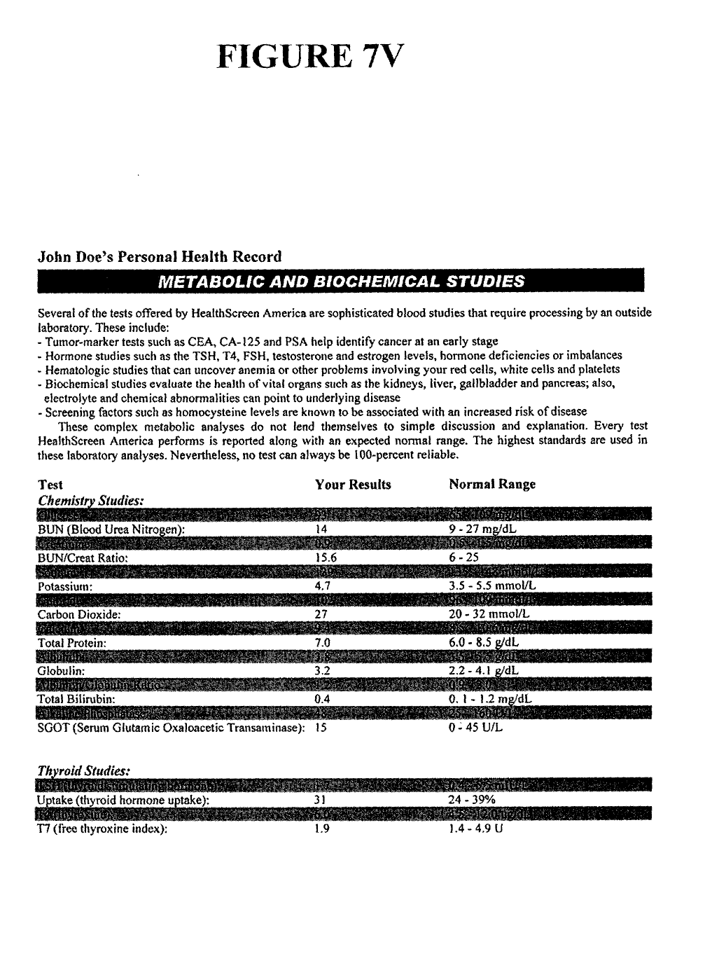

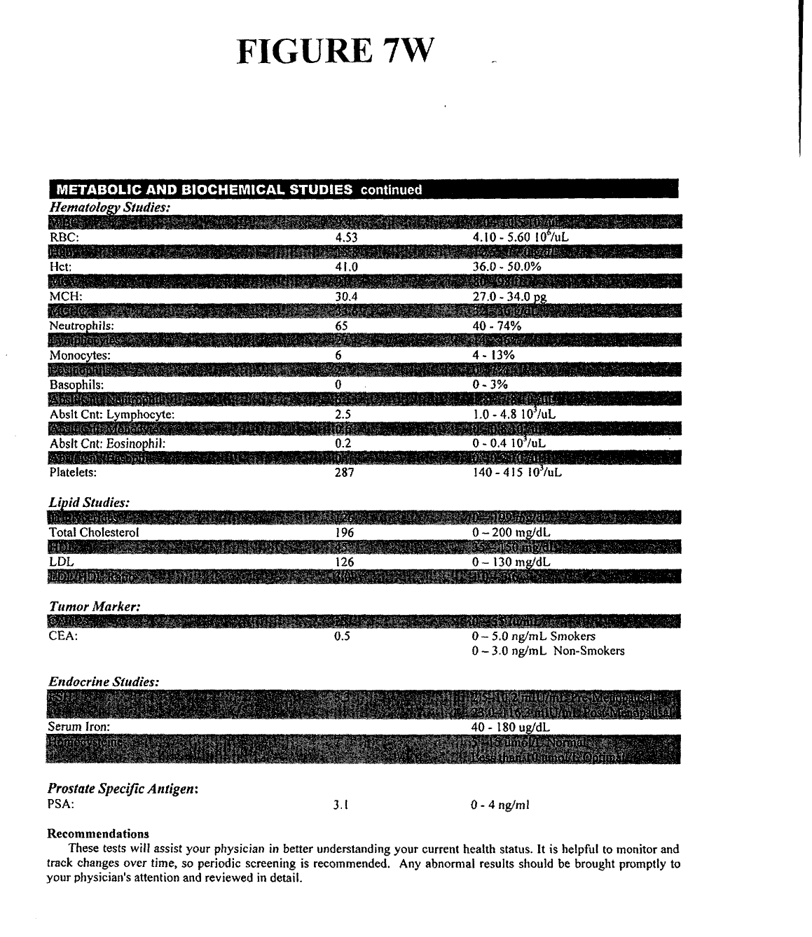

Once all tests are completed, the client may be given a report, an example of which is shown in FIGS. 7A-7W. The printed report preferably includes results from the screening with analysis and recommendations well as a summary for the physician. For example, the suggestion to eat a low fat diet and increase exercise could be passed on from the American Heart Association to a client with high body fat content and high cholesterol levels. In the preferred embodiment, only suggestions and recommendations widely accepted by the medical community and supported by well-respected authorities in the field, such as the American Diabetes Association, are made to consumers. However, under circumstances in which this invention is practiced by the consumer's personal physician, the preferred embodiment could include additional recommendations. The only test results that could not be included on the immediate report are those requiring medical review, such as the CT lung scan which needs to be reviewed by a radiologist. The client may be informed those results will be sent within a few days.

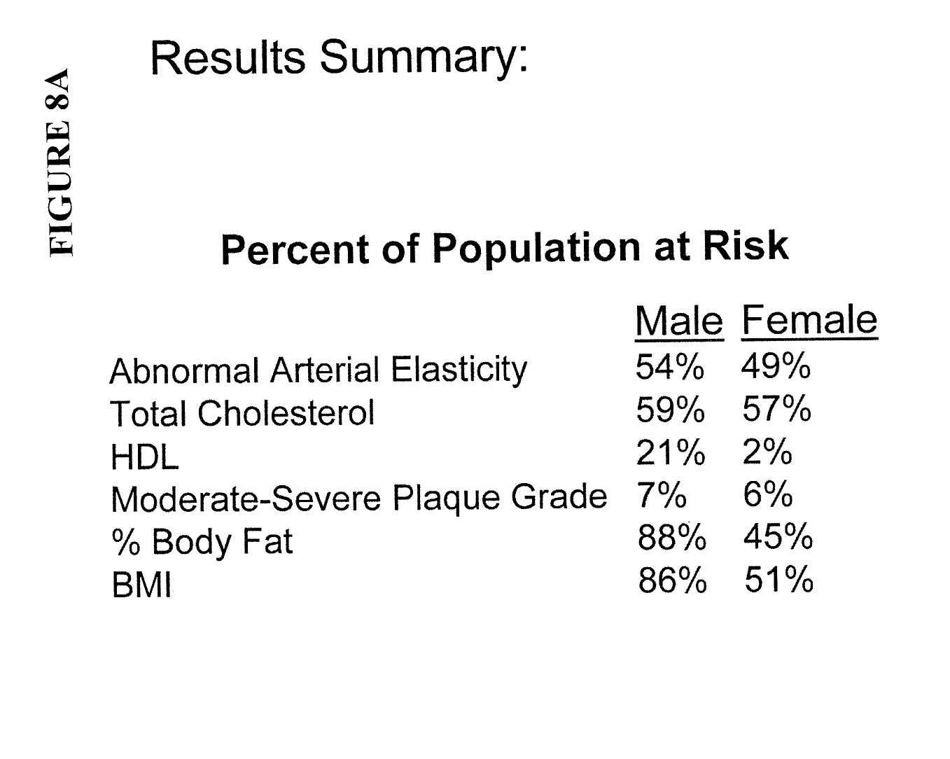

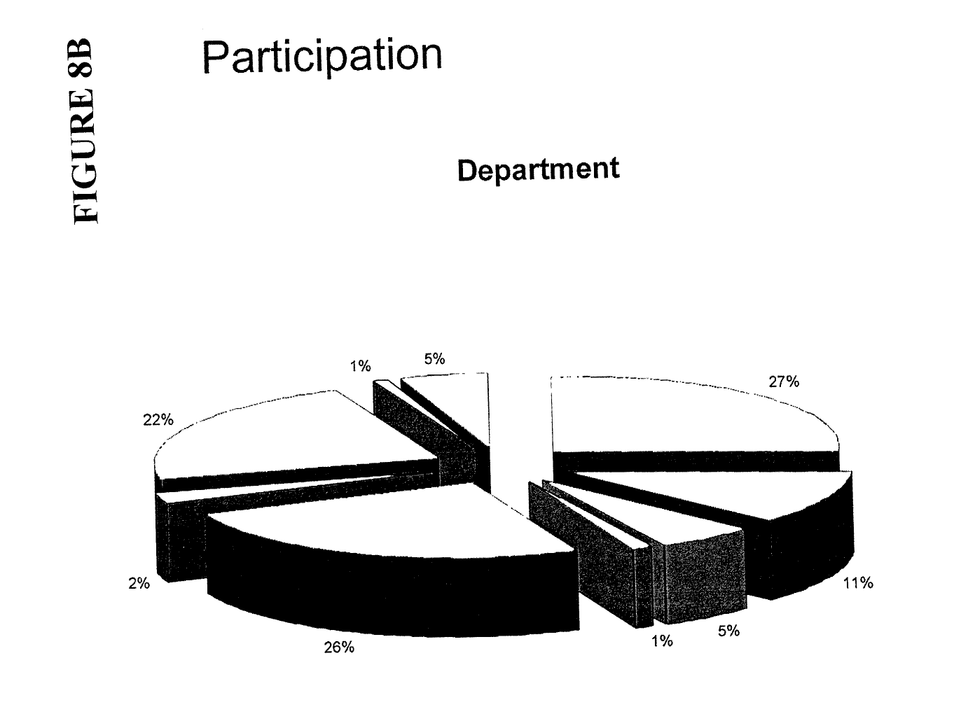

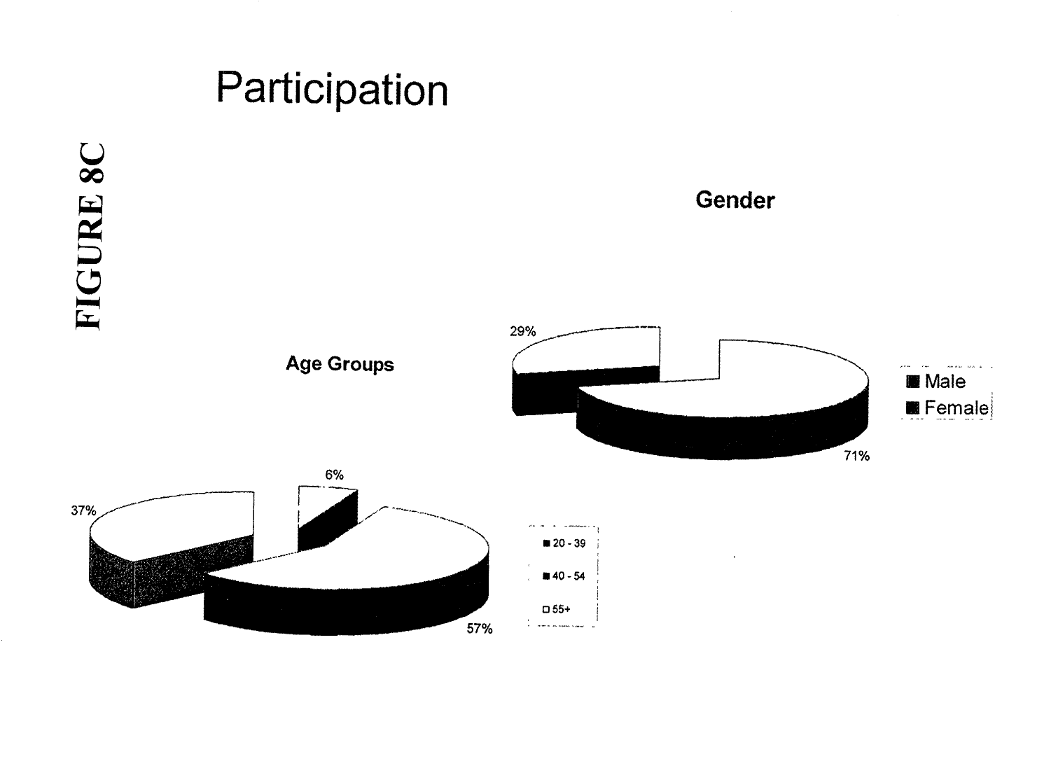

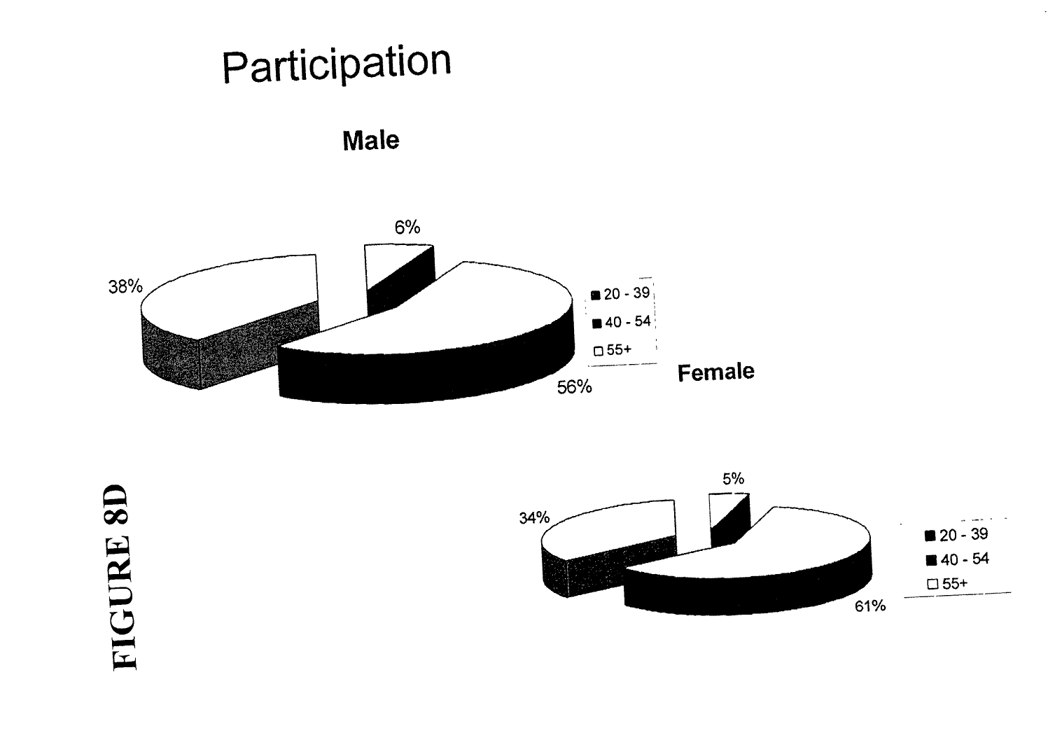

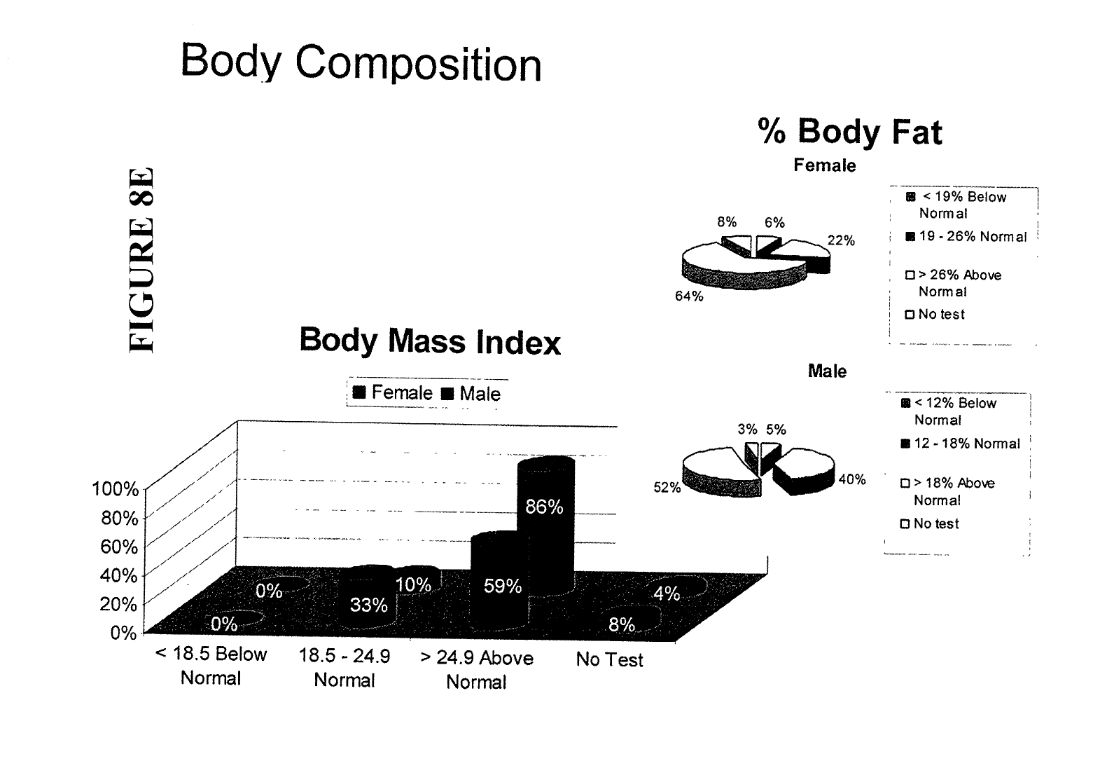

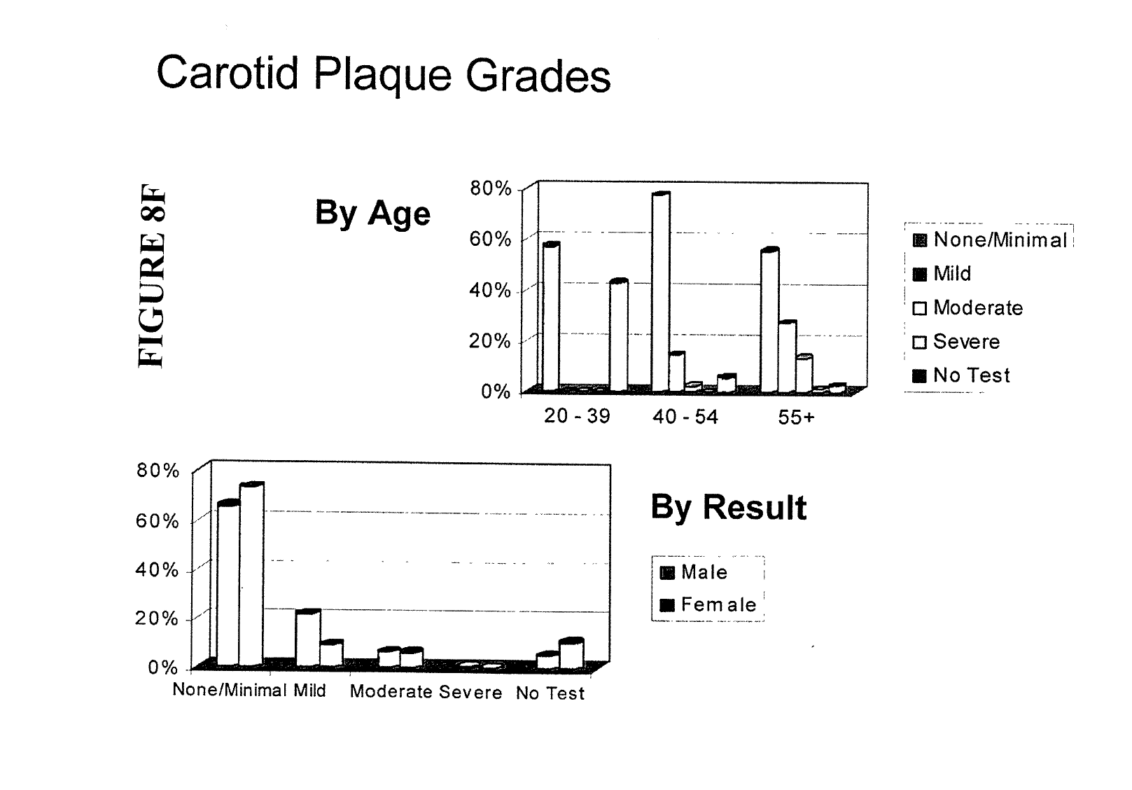

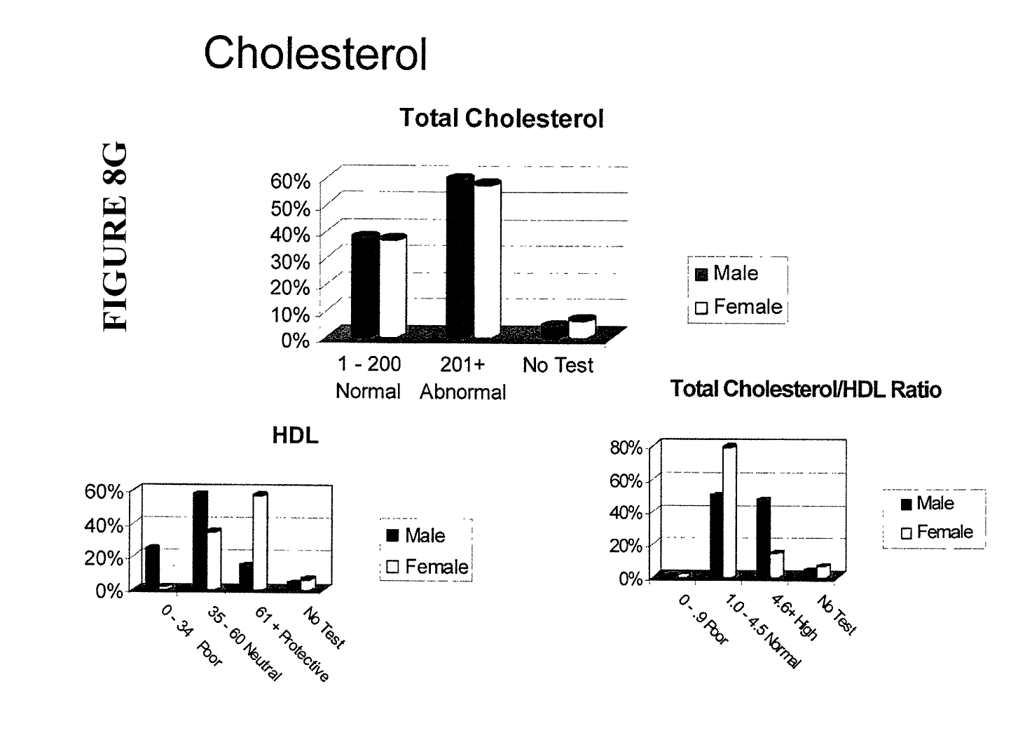

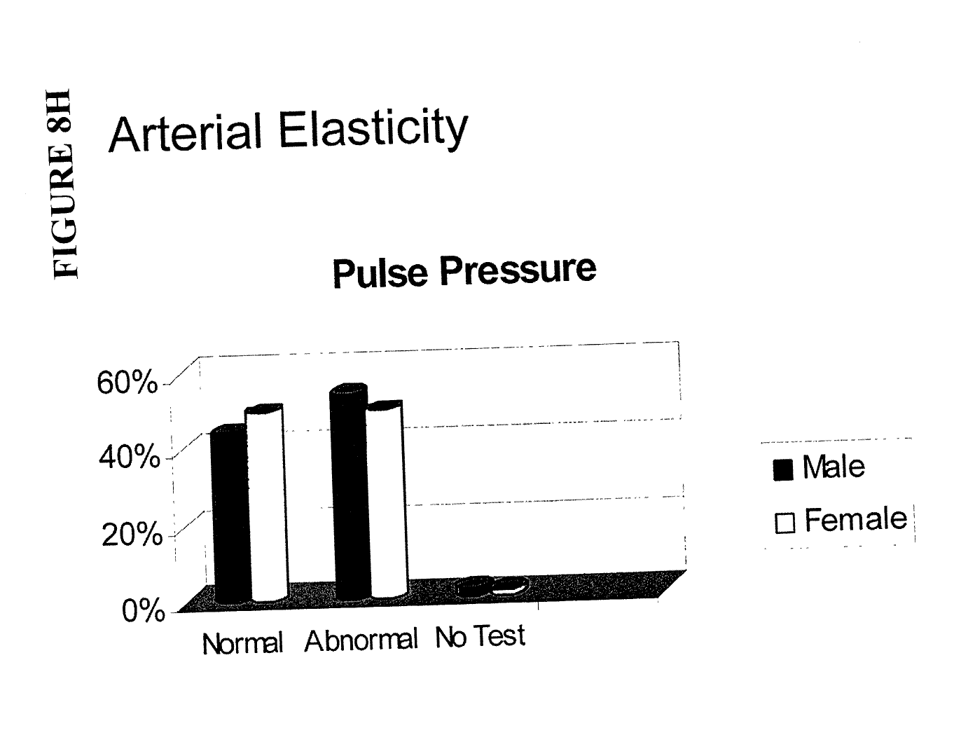

For events hosted by businesses and organizations, an additional report may be generated which employers may use to design effective wellness programs for their employees, an example of which is shown in FIGS. 8A-8H.

Part or all of the data can be sent electronically or telephonically, with devices such as fax back, and maintained on a web server for confidential access with typical browsers. The health and demographic data collected from the screening can pre-populate a life-long health record, which is an electronic health record which may be maintained and updated for a consumer. The life-long health record provides for viewing of the screening results electronically and for downloading for printing—providing a complete report of the screening tests and health risk assessment results (an example of such a report is shown in FIGS. 10A-10J). The life-long health record also provides for input screens for the consumer to add helpful information to complete the health history, from records of immunizations, medications previously or currently taken, and physician's contact information to search screens that allow the consumer to search for more information on a specific condition or to locate a new health care giver.

The data may also be viewed by other well-known techniques such as email, interactive television, and the like. The computer site is preferably viewed with a client web browser as an HTML document through a web secure server communicating with an application server having a database therewith. In the preferred embodiment, the client is assigned a password to use on the Internet web site which stores the test results, downloaded directly from the database. This allows immediate, secured access to the records by the consumer and appropriate physician. Additional reports can be printed and information can be updated to include other health records; however, no changes can be made to the test results. Other educational information can also be found on the web site and links are provided to additional helpful sites. Each time a client returns for additional testing, the database and lifelong health record on the web site are automatically updated through the database.

The web site may also be used by consumers who have not had any screening tests performed at the facility or mobile site. Health-related educational information, facility information, interactive quizzes and activities as well as links to other helpful health web sites may be incorporated. The web site may generate additional clients for the health screening tests and increase awareness of the need for early detection, thus generating more health screening tests. This in turn increases the pool of statistics to be used for scientific analysis and appropriate candidates for clinical trials.

III. Storage of the Demographic and Screening Information for Analysis and Report Generation

The database has three essential purposes. It stores individual data for consumers to allow them to have greater control over their health and well-being as well as greater, immediate access to their health records. FIGS. 7A-7W is an example of a client report including a detachable section for the client's physician. The report gives comprehensive explanations of each test offered and charts which clearly show the normal ranges for each test. Preformatted and scripted, the report takes only a few minutes to print as the database pulls the information needed from List Manager and the results from the tests taken.

FIGS. 8A-8H illustrate an example of a printed Employer Summary Report, which could be issued after a health event held for a company. The medical facility operating this system, method and program may choose to give such a report to the organization, along with individual reports given only to the individual participants. The employer summary report provides documentation on the overall fitness of the staff, without releasing any private information. It explains each test given, including the possible reasons for the condition and the normal ranges. This example breaks down the overall results of the tests by gender in chart format, showing percentages of those within specific ranges. Recommendations for further medical care or lifestyle changes are also included. Such a report, in print or electronic media, can help the organization develop a wellness program that will benefit more of their employees because it pinpoints the greatest needs. In turn, healthier employees experience less absenteeism and the organization's productivity increases.

As screening data is collected from individual consumers, the aggregate of information may also be maintained for scientific research. This invention amasses critical data on a largely a-symptomatic population by storing all the medical and demographic information without any personal identifiers. That information can help the medical community develop trend data and risk assessments on a far wider population than has generally been available before. Up until now, most databases have information on patients who already have symptoms, full-fledged diseases, or passed away. In some cases, determinations of risk are based on a population that is largely deceased. Yet, we all know that people are living longer and healthier lives today. At the same time, some risk factors have increased. For instance, the United States has a greater percentage of obese people than at any other time in the last century. Moreover, the fastest growing segment of obesity is found in the under 21 population. If new ways of combating obesity are not discovered through scientific research and clinical trials, the United States could be looking at far greater instances of obesity-related disease in the next 20-40 years. Having more current information available to the medical community can translate into tremendous leaps forward in preventive care and early intervention.

Reports can be generated that detail risks according to location, age, gender and specific medical factors. Medical personnel can use that information to populate clinical trials with a cross-section of people at increased risk. To date, most clinical trials for preventive care rely upon advertising to the public in hopes of getting responses from those who are at greater risk. For instance, a large Tomaxofen study advertised for women who have had some family history of breast cancer. Researchers were forced to rely upon the accuracy of the women's memories, and, in some cases, stories repeated by family members but not experienced by the women, themselves, when choosing candidates for the study. With this invention, researchers will be able to choose candidates whose DNA contains the specific gene related to increased risk of breast cancer.

A clinical trial based upon known evidence of risk factors could prove invaluable and produce more accurate results. For example, a clinical trial could use the more concrete criteria of at least 30% but not more than 45% calcified plaque in the coronary arteries to test medication for the prevention of heart attack. The database would generate a report based on the health screening of those participants who authorized information be released for clinical trials, and those people could be contacted directly by the medical personnel running the trial.

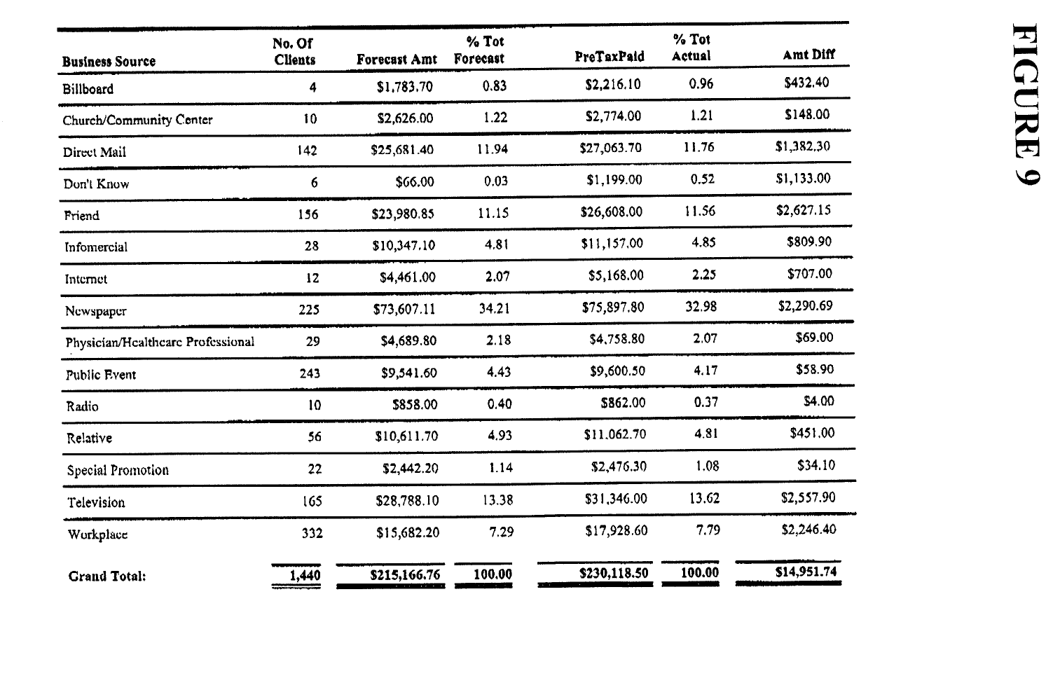

In addition, other reports can be generated, from those that show the source of business for the health-screening center (FIG. 9) to those that delineate overall results from all participants by test. Results of these reports can be used to pinpoint areas or groups of people who may need further education about the importance of early detection and preventive care in addition to business forecasting. Custom reports can list the normal, abnormal and total for each test for a specific period of time or the abnormal result percentage for each test. This data can be used for trending forecasts and immediate risk assessments.

Accordingly, the advantages of the present invention are numerous. For example, the knowledge that consumers can take part in comprehensive health screening without incurring penalties from their insurance companies or employers frees consumers to become better informed and armed to fight off disease through early intervention. Viewing and fully understanding concrete test results often provides the needed catalyst to seek treatment and/or make positive lifestyle changes. Being able to access the reports immediately through the Internet provides a greater measure of security while traveling, if a medical emergency should arise. Immediate accessibility to the client's lifelong health record also makes changing doctors or seeking second opinions easier and faster than waiting for medical records from a physician's office. Automatic updating of the records every time health screening tests are taken provides a complete, convenient record that may span most of the consumer's lifetime, creating a more thorough record than is generally available. The additional information the consumer may add, such as the results of physician ordered tests or a record of medicine taken and any adverse effects could prove invaluable.

Although the invention has been described with respect to a health screening model, it is contemplated that other industries which utilize a centralized data management system with screening facilities may come within the scope of this invention as applicable.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention. User input may be received from the keyboard, mouse, pen, voice, touch screen, or any other means by which a human can input data into a computer, including through other programs such as application programs.

It should be understood that the examples and embodiments described herein are for illustrative purposes only and that various modifications or changes in light thereof will be suggested to persons skilled in the art and are to be included within the spirit and purview of the claims.

What is claimed is:

1. A method for centralized health screening and data mangement comprising:
a) providing a plurality of remotely located screening units;
b) providing a centralized health data management system; and
c) enabling data communication between the centralized health data management system and each of the screening units, wherein each of the screening units provides for:
i) gathering information from a client, said information comprising demographic data, health data, and risk assessment data;
ii) conducting a medical screening on the client, wherein said screening comprises at least one test;
iii) transmitting said information and results from said at least one test to said centralized health data management system; and
iv) generating a report for the client according to an analysis of the results taken in conjunction with said information provided by said health data management system.

2. The method of claim 1 wherein said remotely located screening units comprise screening centers.

3. The method of claim 2 wherein said screening centers comprise at least one mobile unit associated therewith, wherein said screening center dispatches said mobile unit to a remote location.

4. The method of claim 3 wherein said mobile units are configured specifically for each location for which said mobile unit is dispatched.

5. The method of claim 3 wherein said screening center provides for replication of data in said mobile unit.

6. The method of claim 3 wherein data received by said mobile unit is transmitted for storage in said centralized health data management system.

7. The method of claim 1 wherein risk assessment data is gathered from the client by utilizing a predetermined series of questions designed to elicit data associated with a plurality of risk factors.

8. The method of claim 1 wherein the step of conducting medical screening on the client comprises:
assigning a unique client identifier to the client;
assigning a unique screening identifier for said medical screening;
associating said client identifier with said screening identifier;
recording start time of said screening;
conducting at least one test; and
recording end time of said screening.

9. The method of claim 8 further comprising:
storing said information and results from said at least one test in a database associated with said centralized health data management system;
associating a unique test identifier for each test taken by the client with said client identifier; and
assigning a unique results identifier, said results identifier associated with said client identifier.

10. The method of claim 7 wherein said analysis of the results taken in conjunction with said information provided by said health data management system comprises, for each of a plurality of risk factors,
a) assigning unique identifier for each risk factor,
b) analyzing said risk assessment data; and
c) determining a risk indication for the client for each risk factor.

11. The method of claim 10 wherein said risk indication is a positive or negative indicator.

12. The method of claim 10 further comprising considering a client's age category in determining said risk indication.

13. The method of claim 10 further comprising considering a client's gender in determining said risk indication.

14. The method of claim 10 further comprising considering a client's race in determining said risk indication.

15. The method of claim 1 wherein the report generated for the client according to said analysis comprises:
a screening summary comprising test name, client results, and normal ranges;
a detailed report comprising educational information for each of said tests conducted during client screening, said educational information comprising test name, client results, normal ranges, associated health risks, recommendations, and test protocols; and
a physician's report comprising test name, client results, and normal ranges.

16. The method of claim 1 further comprising pre-populating an electronic health record for remote access by the client.

17. The method of claim 16 wherein the step of populating an electronic health record for remote access by the client comprises:
establishing a remotely accessible secure file for said client;
storing demographic information collected from said client;
storing test results for said client for each screening;
allowing client to update file with additional data;
allowing client to control access to data by others.

18. The method of claim 1 wherein said steps are performed for each of a plurality of clients in an organization wherein said organization has assigned thereto a unique organization identifier and said organization identifier is associated with each client who is a member of the organization.

19. The method of claim 18 further comprising assigning a unique department identifier for each department in said organization wherein said department identifier is associated with each client who is a member of the department.

20. The method of claim 18 further comprising generating an organization report, said organization report comprising:
results summary showing percent of organization at risk for at least one category of health risks;
participation percentages by department, age groups, gender, and sex; and
detailed reports showing levels of risk by percentage of clients in each category.

21. The method of claim 1 further comprising combining the results of a plurality of clients in a database of said centralized health management system to provide aggregate information and providing access to said aggregate information.

22. A system for centralized health data management, comprising:
a centralized health data management system;
a plurality of remotely located screening units, each of said screening units comprising:
(a) input means for gathering information from a client, said information comprising demographic data, health data, and risk assessment data;
(b) screening devices for administering a medical screening on the client, wherein said screening comprises at least one test;
(c) communication means for transmitting said information and results from said at least one test to said centralized health data management system; and
(d) output means for generating a report for the client according to an analysis of the results taken in conjunction with said information provided by said health data management system.

23. The system of claim 22 wherein said centralized health data management system comprises processing means for analyzing results in conjunction with risk factors associated with the client and pre-populating an electronic health record for remote access by the client.

24. In a centralized health data management system having a plurality of remote screening units communicating therewith, a computer readable media containing program instructions for outputting data from a computer system, the data being obtained from tables in a database associated with the centralized health data management system, said computer readable media comprising:
first computer program code in each of said remote screening units for gathering information from a client, said information comprising demographic data, health data, and risk assessment data;
second computer program code in each of said remote screening units for recording the results of a medical screening administered to the client, wherein said screening comprises at least one test;
third computer program code in each of said remote screening units for transmitting said information and results to a centralized health data management system;
fourth computer program code in said centralized health data management system for analyzing results in conjunction with risk factors associated with the client; and
fifth computer program code for generating a report for the client according to an analysis of the results taken in conjunction with said information.

25. A centralized system for storing and retrieving health data from a plurality of remote screening units comprising:
a relational database for storing data comprising a plurality of interrelated tables wherein each table comprises an attribute having a common domain with an attribute of at least one other table in the database; and
means for collecting and storing demographic information from a client in said database, the client having assigned thereto a unique client identifier;
means for conducting a medical screening on the client at each of said remote screening units, wherein said screening comprises at least one test;
means for storing results from said at least one test in said database;
means for analyzing results in conjunction with risk factors associated with the client; and
means for generating a report for the client according to said analysis on the basis of the data stored in the relational database.

26. The system of claim 25 further comprising means for pre-populating an electronic health record for remote access by the client.

27. The system of claim 25 further comprising a plurality of dispatchable mobile units associated with said remote screening units, said mobile units selectively configured to provide means for collecting and storing demographic information from a client in said database and means for conducting a medical screening on the client.
